(19) United States
(12) Patent Application Publication
(10) Pub. No.: US 2026/0288905 A1
(43) Pub. Date: Sep. 24, 2026

(54) REPARAMETERIZED CLUSTERING ALGORITHM TO HARVEST IN-CONTEXT EXAMPLES FOR NL2SQL

(71) Applicant: Oracle International Corporation, Redwood Shores, CA (US)

(72) Inventor: Duy Vu, Melbourne (AU)

(73) Assignee: Oracle International Corporation, Redwood Shores, CA (US)

(21) Appl. No.: 19/564,934

(22) Filed: Mar. 12, 2026

Related U.S. Application Data
(60) Provisional application No. 63/773,568, filed on Mar. 18, 2025.

(51) Int. Cl. G06F 18/2321; G06F 16/22; G06F 18/2137; G06F 18/22

(52) U.S. Cl. CPC G06F 18/2321; G06F 16/2237; G06F 18/2137; G06F 18/22

(57) ABSTRACT

Techniques are provided for a clustering algorithm to harvest in-context examples from Text-to-SQL logs. The method includes receiving vector representations of natural language utterances and corresponding queries in a programming query language. The clustering algorithm may be reparametrized using a training dataset by sampling the vector representations, estimating local radius parameter values from a distribution of pairwise distances, and iteratively executing the clustering algorithm while incrementally relaxing density constraints to identify paraphrases and unique queries. Hyperparameter tuning may be performed by adjusting clustering parameters based on evaluation metrics to obtain a fine-tuned algorithm. The method can further augment examples with ground truth examples and execute the fine-tuned clustering algorithm on the augmented set to generate clustered data points representing groups of paraphrases and unique queries. These clustered results may then be used to fine-tune or train a generative model, improving Text-to-SQL system performance and adaptability.

### CROSS REFERENCE TO RELATED APPLICATIONS

The present application claims the benefit of U.S. Provisional Application No. 63/773,568 filed on Mar. 18, 2025, the entire disclosure of which is incorporated herein by reference in its entirety for all purposes.

### FIELD

The present disclosure relates generally to converting natural language to a logical form, and more particularly, to techniques for a clustering algorithm to harvest in-context examples from Text-to-SQL logs.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents data augmentation techniques for the implementation and improvement of text-to-query language technologies, including SQL, ensuring that the benefits of these advancements can be realized across various domains.

### BRIEF SUMMARY

Techniques are disclosed herein (e.g., a computer implemented method, a system, and a non-transitory computer-readable medium storing code or instructions executable by one or more processors) for a clustering algorithm to harvest in-context examples from Text-to SQL logs. The algorithm implements a data-driven, domain-adaptive approach for reparameterization of the DBSCAN clustering algorithm by estimating the local radius parameter (eps) via empirical distance percentiles computed from sampled point-to-all distance distributions. The method iteratively relaxes density constraints by jointly increasing the epsilon parameter and decreasing the min_samples parameter, while removing clustered data at each pass, thus capturing both tight and looser paraphrase groups. Dimension reduction techniques, such as UMAP, are incorporated to mitigate the effects of high-dimensional text embeddings and further enhance clustering quality. Additionally, the algorithm performs hyperparameter tuning across embeddings, reduction parameters, and DBSCAN settings, optimizing for homogeneity, completeness, data coverage, and intent recall across varied database schemas. Seeding clustering with labeled in-context examples further tightens clusters and reduces intent mixing, leading to empirically validated improvements in clustering metrics. Together, these features provide a scalable, end-to-end solution for the dynamic curation and enrichment of in-context examples, ensuring that text-to-SQL systems remain accurate and adaptive as user needs and database domains evolve.

In various embodiments, a computer-implemented method includes comprises: receiving vector representations of examples comprising natural language utterances and corresponding queries in a programming query language; reparametrizing, using the vector representations, a clustering algorithm for identification of paraphrases of the examples and the examples having unique queries, based on: sampling the vector representations to obtain a set of sampled vector representations; estimating parameter values for a local radius parameter from a distribution of pairwise distances determined between each of the sampled vector representation in the set of vector representations and each vector representation in the vector representations, and iteratively executing the clustering algorithm on the set of sampled vector representations, based on incrementally relaxing density constraints from high-density to low-density clusters based on the estimated parameter values for the local radius parameter and parameter values for a minimum samples parameter, to generate a reparametrized clustering algorithm; performing hyperparameter tuning on the reparametrized clustering algorithm by iteratively adjusting, based on clustering evaluation metrics, hyperparameters of the reparametrized clustering algorithm to generate a finetuned reparametrized clustering algorithm; augmenting the examples with ground truth examples to generate augmented examples; executing the fine-tuned reparametrized clustering algorithm using the augmented examples to generate clustered data points, wherein the clustered data points represent groups of the paraphrases of the examples and the examples having the unique queries; and fine-tuning or training a generative model using at least the paraphrases of the examples and the examples having the unique queries.

In various embodiments, the vector representations are generated by: embedding, by an embedding model, the natural language utterances and corresponding programming query language into vectors, wherein hyperparameters of the embedding model are evaluated based on clustering evaluation metrics; and reducing, using a dimension reduction algorithm, dimensions of the vectors to obtain the vector representations, wherein hyperparameters of the dimension reduction algorithm are evaluated based on the clustering evaluation metrics.

In various embodiments, estimating parameter values for the local radius parameter comprises: for each sampled vector representation in the set of vector representations: (i) computing distances between the sampled vector representation and each vector representation in the vector representations, (ii) identifying nearest neighbor distances and distant neighbor distances, and (iii) aggregating the nearest neighbor distances and the distant neighbor distances to generate a neighbor distance pairwise distribution corresponding to the vector representation; and determining an initial value for the local radius parameter as a low percentile of the neighbor distance pairwise distributions for the subset of vector representations, a final value for the local radius parameter as a high percentile of the neighbor distance pairwise distributions for the subset of vector representations, and an incremental value for the local radius parameter as the difference between the final value and the initial value divided by a number of clustering iterations.

In various embodiments, the minimum samples parameter comprises a smallest minimum sample value, a largest minimum sample value, and an incremental value, wherein the incremental value is set so that cluster size progresses from tight/large clusters to looser/smaller clusters.

In various embodiments, the reparametrizing further comprises, after each executed iteration of clustering, removing clustered data points from the vector representations such that subsequent iterations of the hyperparameter tuning are performed on un-clustered data points.

In various embodiments, the clustering evaluation metrics comprise a combination of at least two clustering evaluation metrics selected from a group consisting of homogeneity, completeness, v-measure, data coverage, and intent recall, and the combination of the at least two clustering evaluation metrics is a weighted combination of the selected clustering evaluation metrics.

In various embodiments, generating the augmented examples comprises adding a proportion of the ground truth examples to the examples, wherein the proportion is selected as a percentage of the number of examples.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are merely exemplary.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL model, according to various embodiments.

FIGS. 5A and 5B show histograms displaying the distribution of the number of examples across various database schema per.

FIGS. 6A and 6B show hyperparameter optimization graphs illustrate the progression and convergence of equally weighted homogeneity and completeness clustering metrics (y-axis) over the course of a hyperparameter tuning iterations (x-axis) for the MUSE text embedding model (FIG. 6A) and the MUSE+ConveRT embedding models (FIG. 6B).

FIGS. 7A and 7B show hyperparameter optimization graphs illustrate the progression and convergence of equally weighted homogeneity and completeness, data coverage, and intent recall criterion clustering metrics (y-axis) over the course of a hyperparameter tuning iterations (x-axis) for the MUSE text embedding model (FIG. 7A) and the MUSE+ConveRT embedding models (FIG. 7B).

FIG. 8 is a flowchart illustrating a process for leveraging a clustering algorithm for harvesting in-context examples from Text-to-SQL production logs, according to various embodiments.

FIG. 9 is a block diagram illustrating one pattern for implementing a cloud infrastructure as a service system, according to various embodiments.

FIG. 10 is a block diagram illustrating another pattern for implementing a cloud infrastructure as a service system, according to various embodiments.

FIG. 11 is a block diagram illustrating another pattern for implementing a cloud infrastructure as a service system, according to various embodiments.

FIG. 12 is a block diagram illustrating another pattern for implementing a cloud infrastructure as a service system, according to various embodiments.

FIG. 13 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

In recent years, the amount of data powering different industries and their systems have been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of their business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with databases via natural language (NL) queries, thereby abstracting away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, such as SQL, PQL, GraphQL, and SPARQL among others. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL can also enable digital assistants, such as chatbots and others, to provide improved responses when answers can be found across different databases or tables with varying schemas.

In some instances, NL2SQL transforms natural language into SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token from the fixed vocabulary should appear next in the output sequence.

SQL is a standard database management language for interacting with relational databases. SQL can be used for storing, manipulating, retrieving, and/or otherwise managing data held in a relational database management system (RDBMS) and/or for stream processing in a relational data stream management system (RDSMS). The main goal of the Text-to-SQL model is to allow end users interact with their SQL databases through natural languages (NL) rather than SQL queries. Using a Text-to-SQL service, business analysts can extract information from their databases without thorough knowledge of SQL and the database schemas. In addition to the database schema, the main input to the Text-to-SQL model is a natural language question. For example: “tell me invoices starting with IBY7”. The main output from the Text-to-SQL model is an SQL query. For example: “SELECT*FROM accounts_payable_invoices WHERE LOWER(INVOICE_NUMBER) LIKE LOWER(‘iby7%’)”.

As discussed above, generative models such as LLMs that are either pre-trained or fine-tuned have emerged as the dominant approach to solving the Text-to-SQL problem, yielding state-of-the-art results. When applying these models to a new domain, it is important to provide additional metadata information beyond just the database schema described in Data Description Language (DDL), in order to maximize the accuracy of the generated SQL queries in response to input questions. Examples of such metadata include (1) Schema information e.g., table and column descriptions; (2) Business rules, e.g., mappings between domain terms and SQL filters; (3) Generation guidelines e.g., instructions for creating date and time expressions; and (4) In-context examples that show how to apply the first three categories of metadata in specific situations. This disclosure focuses on the curation of in-context examples, which have been shown to significantly improve model performance across a range of query complexities. In-context examples are selected pairs of natural language questions and their corresponding SQL queries, often curated from historical logs or annotated datasets, that serve as reference points for the model to interpret and translate new user queries more effectively. While such reference pairs enhance model interpretation, static collections of in-context examples rapidly become outdated as user requirements and database schemas continually evolve. Manual updates and fine-tuning, though beneficial for long-term improvements, are resource-intensive and slow to address immediate needs. Consequently, there is a clear necessity for automated, adaptive curation methods that can dynamically identify, update, and maintain in-context examples, ensuring that Text-to-SQL applications remain accurate, responsive, and robust in changing production environments.

To overcome these challenges and others, the techniques disclosed herein leverage a re-parameterized, iterative DBSCAN clustering algorithm to identify in-context examples from production logs. This algorithm continuously adapts the curated examples in response to changing user needs, thereby improving the performance of Text-to-SQL models across new database domains. The clustering algorithm addresses the inefficiencies of the standard DBSCAN by estimating the epsilon parameter as a percentile of the empirical distribution of pairwise distances, calculated using only a sampled subset of data points. This domain-adaptive re-parametrization reduces computational complexity from O(n\hat{ }2) to O(n) and eliminates trial-and-error tuning, enabling scalable and accurate cluster formation for the dynamic curation and maintenance of in-context examples.

Additionally, the algorithm executes clustering iterations by jointly varying epsilon and min_samples, moving from strict density constraints to more relaxed ones, and incrementally removing clustered points to recover both tightly grouped and loosely related paraphrase clusters. Dimension reduction techniques, such as UMAP, are incorporated to mitigate the curse of dimensionality in high-dimensional text embeddings, thereby improving clustering quality and ensuring that clusters remain separable. Hyperparameter tuning across embedding models, reduction algorithms, and DBSCAN settings is performed using comprehensive training and validation datasets by optimizing multiple clustering metrics, enabling robust default parameter selection that generalizes across diverse database schemas. The pipeline further leverages semi-supervised seeding, wherein labeled in-context examples are mixed with unlabeled production logs to tighten cluster boundaries and reduce intent mixing, resulting in improved metrics such as homogeneity, completeness, coverage, and intent recall. Empirical assessments confirm that the disclosed re-parameterized DBSCAN outperforms the standard DBSCAN algorithm and single-iteration variants, delivers superior clustering quality, and enhances annotation efficiency through features such as LLM-generated cluster summaries and prioritization signals.

In various embodiments, a computer implemented method is provided comprises: receiving vector representations of examples comprising natural language utterances and corresponding queries in a programming query language; reparametrizing, using the vector representations, a clustering algorithm for identification of paraphrases of the examples and the examples having unique queries, based on: sampling the vector representations to obtain a set of sampled vector representations; estimating parameter values for a local radius parameter from a distribution of pairwise distances determined between each of the sampled vector representation in the set of vector representations and each vector representation in the vector representations, and iteratively executing the clustering algorithm on the set of sampled vector representations, based on incrementally relaxing density constraints from high-density to low-density clusters based on the estimated parameter values for the local radius parameter and parameter values for a minimum samples parameter, to generate a reparametrized clustering algorithm; performing hyperparameter tuning on the reparametrized clustering algorithm by iteratively adjusting, based on clustering evaluation metrics, hyperparameters of the reparametrized clustering algorithm to generate a finetuned reparametrized clustering algorithm; augmenting the examples with ground truth examples to generate augmented examples; executing the fine-tuned reparametrized clustering algorithm using the augmented examples to generate clustered data points, wherein the clustered data points represent groups of the paraphrases of the examples and the examples having the unique queries; and fine-tuning or training a generative model using at least the paraphrases of the examples and the examples having the unique queries.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action is based at least in part on at least a part of the something.

### Overview of Agents and NL2SQL Framework

An agent (also referred to as a skill, chatbot, chatterbot, talkbot, digital assistant, or the like) is a computer program that can engage in conversations with end users. The agent can generally respond to natural language messages (e.g., questions or comments) through a messaging application that uses natural language messages. Enterprises may use one or more agent systems to communicate with end users through a messaging application. The messaging application, which may also be referred to as a channel, may be an end user's preferred messaging application that they have already installed and are familiar with. Thus, the end user does not need to download or install new applications in order to chat with the agent system. The messaging application may interface with, for example, over-the-top (OTT) messaging channels (such as Facebook Messenger, WhatsApp, WeChat, Line, Kik, Telegram, Talk, Skype, Slack, or SMS); virtual private assistants (such as Amazon Alexa, Google Assistant, Apple Siri, or Microsoft Cortana, accessible through devices like Amazon Echo, Google Home, Apple HomePod, or compatible mobile devices); mobile and web app extensions that add chat capabilities to native or hybrid/responsive apps or web applications; or voice-based input (such as devices or apps that utilize Siri, Google Assistant, Alexa, Cortana, or other speech-based interfaces).

End user may interact with the agent system through a conversational interaction (sometimes referred to as a conversational user interface (UI)), similar to interactions between people. In some cases, the interaction may include the end user providing an utterance such as the query: “Please retrieve all invoices greater than ten thousand dollars for the last four years for Customer Y”, to the agent, and the agent responding with a natural language response based on translation of the user's natural language query to an SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or another method of conveying a message. In some embodiments, the agent system may convert the content into a standardized logical form (e.g., an SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

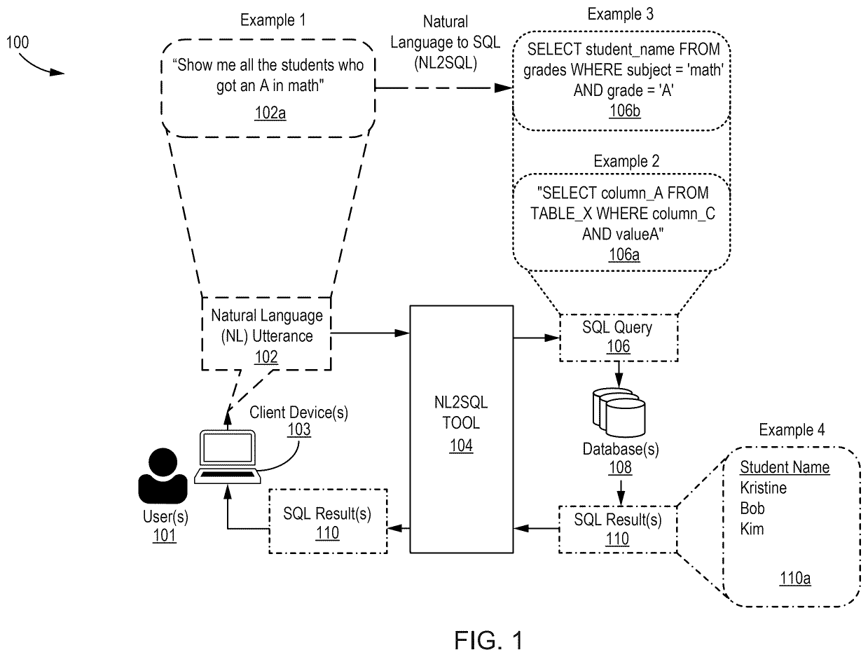

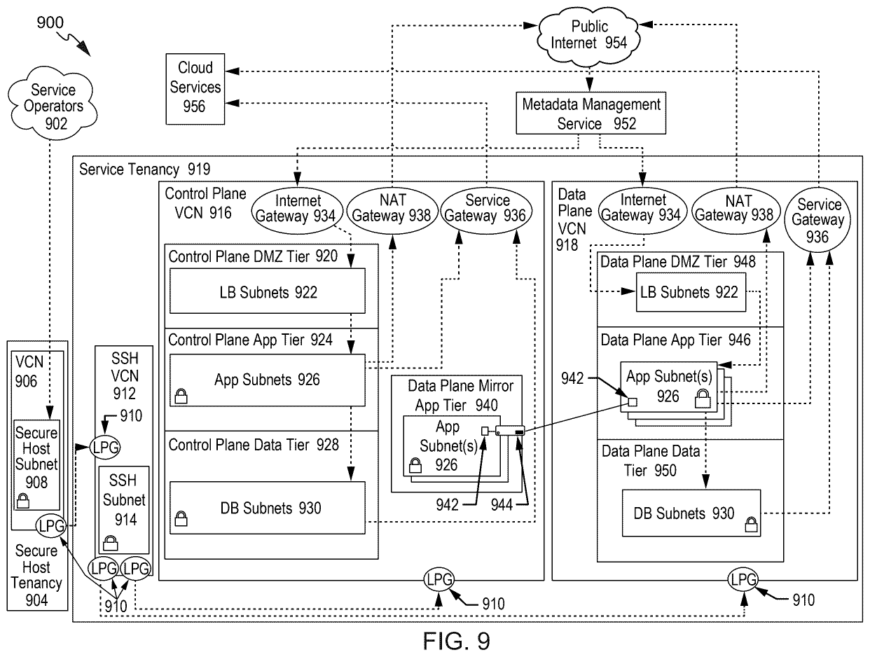

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for the query). As shown in FIG. 1, the NL2SQL tool 104 is configured to generate an SQL query 106 and one or more SQL query result(s) 110 based on the provided natural language utterance 102; however, other examples may implement tasks in addition to or in alternative to SQL query generation (e.g., schema checking, schema linking, sentence completion, extraction of key information, debugging, and other SQL-related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 9-13) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensuring high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be, or include a natural language utterance 102. The natural language utterance can be in text form, such as when the user types a sentence, a question, a text fragment, or phrase and provides it as input to the NL2SQL tool 104 via client device(s) 103. The client device(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone tool, as a plug-in, or make use of another audio-to-text translator, configured to translate the audio into text for further processing.

The NL2SQL tool 104 may be, or may make use of, one or more generative artificial intelligence models such as LLMs configured to generate an SQL query 106 (e.g., 106a or 106b) based on the natural language utterance 102. The NL2SQL tool 104 may receive a prompt including the natural language utterance 102 to generate an SQL query 106 that is relevant to the preferences of user 101. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., by populating slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain an SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via other means such as an email communication, SMS message, or other types of notification receivable on one or more other computing devices. In some implementations, the SQL query 106 is provided to the user(s) in addition to or instead of running the SQL query 106 on the database(s) 108 to obtain SQL result(s) 110 (e.g., as part of a feedback request to validate the SQL query 106).

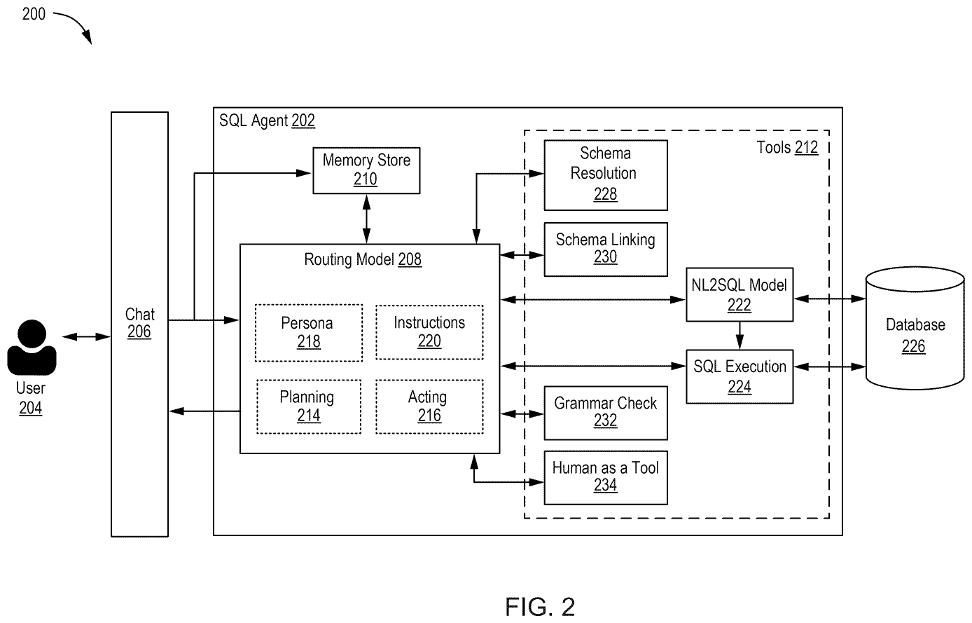

FIG. 2 is a simplified block diagram of an SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence models can generate SQL statements. The purpose of the SQL agent system 200 is to enable users to interact with their databases with the least amount of effort. This may include the SQL agent system 200 interpreting user requests in natural language, reviewing database schema, implementing schema linking (i.e. identifying names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include an SQL agent 202 capable of converting a natural language question into an SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that comprises a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates an SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve the accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing SQL queries |
| | who requires assistance in writing and optimizing SQL |
| | queries. |
| Expert Developer | A user with several years of experience writing SQL queries. |
| Business Analyst | A user with strong context about the needs of a company |
| | and who wants quick data insights without deep SQL |
| | knowledge. |
| Data Scientist | A user focused on extracting and analyzing data efficiently. |

Instructions 220 describe the knowledge bases and tools available to the SQL agent 202. Instructions 220 can be included in a prompt for LLM-based tools and may guide a tool to generate a response relevant to the preferences of the user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates an SQL query based on the prompt. The NL2SQL model 222 can be trained to convert a natural language question into an SQL query to help the user 204 complete data related tasks. In some examples, the SQL query generated by the NL2SQL model 222 is returned to the user 204 via the chat 206. Additionally, or alternatively, the generated SQL query is provided to an SQL execution 224 tool that is configured to execute SQL queries on the database 226. SQL execution 224 may receive an SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate a new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within an SQL statement. The SQL agent 202 may use schema resolution 228 after an SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user, such as a developer, for information to correct previous generations.

The SQL agent 202 may use a single tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 204 via the chat 206 as received by the routing model 208 (i.e., without additional modifications to the output).

In some implementations, the routing model 208 responds to the user 204 who provided the original query as part of a two-way conversation (e.g., via chat 206). The natural language response may include a natural language component (e.g., answers to questions, information, etc.) and/or a logical form component (e.g., an SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 204 via the chat 206. In some implementations, the SQL agent 202 may provide a visualization of the generated output through a plot, table, graph, and the like, via the chat 206. As a particular example, the SQL agent 202 can use the schema linking 230 tool to identify names of tables and columns in a natural language utterance (which is an example of NL utterance 102 with respect to FIG. 1) provided by the user 204 and then generate an SQL query using the NL2SQL model 222 based on the identified table and column names. The SQL query may be provided to the user 204 via the chat 206 as generated by the NL2SQL model 222. In some implementations, the routing model 208 may generate a natural language response containing the SQL query and provide the natural language response to the user 204 via the chat 206.

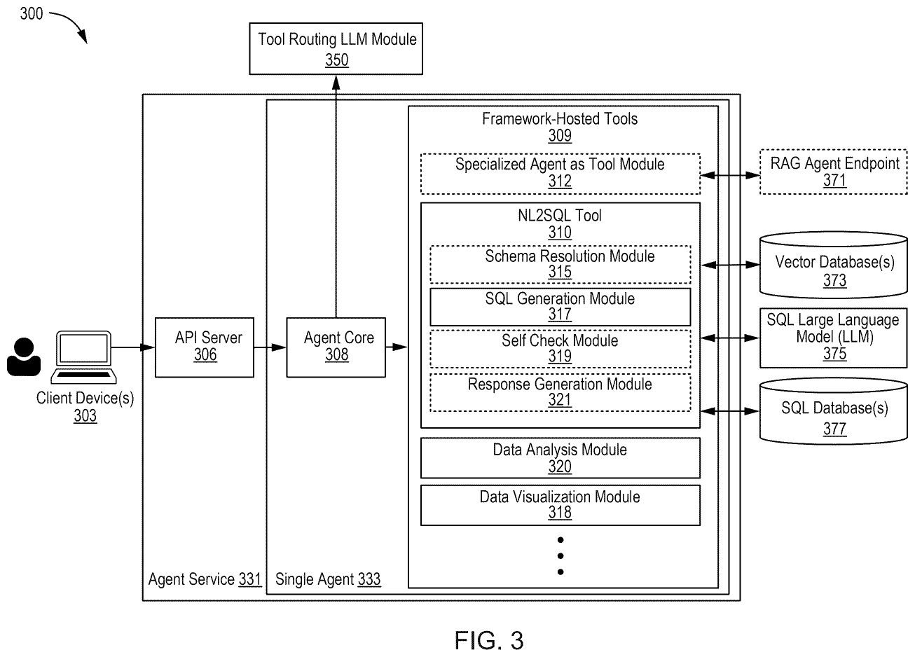

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to communicate as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval-augmented generation (RAG) endpoint 371. The RAG endpoint 371 may improve the efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework-hosted tools 309 is an NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schemas for any errors (e.g., syntax errors, semantic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is an SQL generation module 317. The SQL generation module 317 may take the utterance received from the client device(s) 303 and construct an SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 include data analysis module 320 and a data visualization module 318. Each of 320 and 318 may function with any of the modules of the framework-hosted tools 309 in order to analyze and display the various analytics. The analytics may include analysis of schema, SQL queries, LLM accuracy, recommendations, or suitable equivalents.

### Training, Testing, and Deployment of a NL2SQL Model

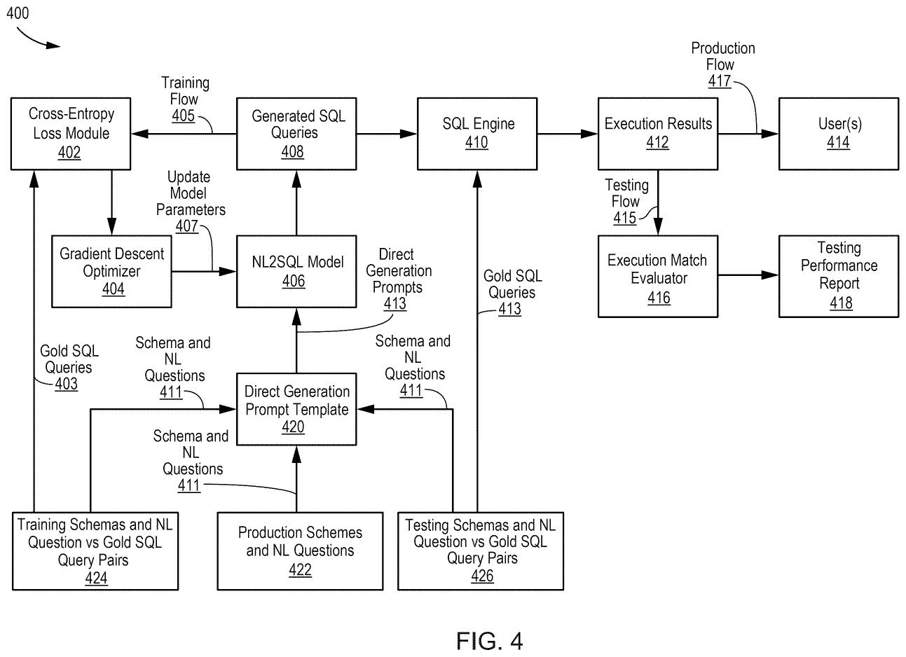

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the description below, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.
For example:
   “Get me the list of employees from Australia.”
The main output from the NL2SQL model is an SQL query.
For example:
   SELECT employee_id, employee_name FROM Employee WHERE country=“Australia”.
Another important input to the NL2SQL model 406 is the database schema that helps the model to identify relevant tables and columns in the SQL output construction.
For example:

CREATE TABLE Employee (
employee_id TEXT(12) NOT NULL,
employee_name TEXT(100) NOT NULL,
birth_date DATE NOT NULL,
hire_date DATE NOT NULL,
country TEXT(100),
...
)
CREATE TABLE JobTitle (
...
)
...

Described herein is a pre-trained NL2SQL model developed based on instruction fine-tuning of LLMs to provide this NL2SQL direct generation capability, e.g., the mapping of (Database Schema, NL Question)>SQL Query. Below is the summary of how the NL2SQL direct generation capability is implemented via instruction fine-tuning.

Data to train a NL2SQL model includes multiple database schemas defined as SQL CREATE TABLE statements:
Table names
Column names and types
Primary and foreign keys
Other constraints

### One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0), aid NUMERIC(9, 0),
PRIMARY KEY (eid, aid), FOREIGN KEY(aid)
REFERENCES aircraft (aid), FOREIGN KEY(eid)
REFERENCES employee (eid))
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno).
  FOREIGN KEY(aid) REFERENCES aircraft (aid)
)
```

Each database schema can be associated with multiple pairs of natural language questions and corresponding SQL queries.

### Example of NL Question and Corresponding SQL Query:

NL Question: “What is the name of the employee with salary greater than 100000 and with the most certificates to fly planes more than 5000?”
SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

Each question-query pair and its corresponding database schema are populated following a NL2SQL direct generation prompt template to create one direct generation prompt example:

### Direction NL2SQL Generation Prompt Example:

Given an input Question, create a syntactically correct Oracle SQL query to run.

Pay attention to using only the column names that you can see in the schema description. Be careful to not query for columns that do not exist. Also, pay attention to which column is in which table. Please double check the SQL query you generate.DO NOT use alias in the SELECT clauses. Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs.) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using an SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 9-13).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into an SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:
“sql
SELECT * FROM customers WHERE signup_date>=DATE_SUB(CURDATE( ), INTERVAL 1 MONTH);
”

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using an SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

Clustering Algorithm to Harvest In-Context Examples from Text-to-SQL Logs

As discussed above, an NL2SQL system is powered by a deep learning model (e.g., an NL2SQL model such as an LLM) configured to convert a natural language (NL) utterance (e.g., a query posed by a user using a digital assistant or chatbot) into a structured query language (SQL) query. When adapting these models to a new domain, it is beneficial to provide additional metadata information beyond just the database schema described in Data Description Language (DDL), in order to maximize the accuracy of the generated SQL queries in response to input questions. It has been demonstrated that in-context examples can significantly improve the performance of NL2SQL models, with gains ranging from 5% for simple cases to 30% for more complex ones. However, static collections of in-context examples fail to address evolving user requirements and the diversity of real-world queries, limiting the model's capacity to generalize across domains. To address this limitation and others, techniques described herein leverage user input logs from production to extract paraphrases of existing in-context examples and in-context examples having unique queries (representing new informational needs). A clustering algorithm is run on the input logs to identify these in-context examples for use with the NL2SQL models.

### Technical Challenges

Integrating in-context examples into prompts for NL2SQL models may significantly improve performance, particularly when handling complex or evolving queries. As NL2SQL models and the underlying databases are updated, the relevance of previously curated in-context examples often decreases, which thus entails continual revision to maintain effectiveness. Conventional approaches for curating such examples typically involve either model fine-tuning or manual selection by subject matter experts, both of which may be labor-intensive and require specialized expertise, thereby limiting scalability and adaptability to new user requirements. To address these obstacles, density-based clustering algorithms, such as Density-Based Spatial Clustering of Applications with Noise (DBSCAN), may be employed to automate the identification and grouping of similar queries from large-scale datasets. The DBSCAN algorithm iteratively examines each data point in a dataset, determining whether it qualifies as a core point based on the number of neighboring points within a specified distance (epsilon). When a core point is found, it forms a new cluster by recursively including all density-reachable points, while points not meeting the density criteria and not already assigned to a cluster are labeled as noise. This process continues until all data points have been processed, resulting in identification of clusters of arbitrary shapes and the separation of outliers.

Despite its utility, the standard DBSCAN clustering algorithm exhibits several limitations that restrict its effectiveness in the context of diverse text-to-SQL domains. The parameters governing DBSCAN, namely epsilon (the neighborhood distance threshold) and min_samples (the minimum number of points required to form a cluster), are highly domain-dependent and lack a systematic method for optimal selection. Determining suitable values for these parameters often necessitates manual trial-and-error tuning, which is inefficient and may yield inconsistent results across varying datasets. Moreover, the epsilon parameter is particularly sensitive to the underlying data distribution, which can differ substantially between text domains. As a result, standardizing hyperparameter configurations is also challenging. DBSCAN also struggles to identify clusters of varying densities within the same dataset, is sensitive to the presence of noise, and may perform suboptimally when the data contains high-dimensional features or when clusters are not well-separated. These factors collectively hinder the scalability and robustness of DBSCAN for automating the curation of in-context examples.

Another technical challenge associated with applying clustering algorithms to NL2SQL models arises from the need to embed text-based input queries, which are typically natural language questions often paired with their corresponding programming query language. The embedding process produces high-dimensional vector representations, and this inherent high-dimensionality degrades clustering quality due to the curse of dimensionality. As distance metrics lose discriminative power, clusters become less distinguishable with increasing dimensions. While dimensionality reduction techniques may be used to mitigate these effects, their application introduces additional parameters that also need to be selected and optimized (e.g., the choice of reduction algorithm and the target dimensionality), thereby increasing the complexity of the clustering pipeline. This also increases the risk that suboptimal choices will further diminish the effectiveness of in-context example identification.

### Technical Solutions

The present application addresses the aforementioned challenges by introducing a re-parameterized, iterative clustering algorithm for identifying in-context examples. Instead of relying on fine-tuning methods described above, the present disclosure leverages Text-to-SQL input logs from production to identify and address current model deficiencies. By analyzing the production question logs, the present techniques can achieve two key tasks in the curation of in-context examples: First, they can identify paraphrased versions of questions that are already covered by existing in-context examples, thereby enhancing the model's robustness to various linguistic expressions used by different users. Second, they can uncover new information needs that the current model fails to address. By incorporating these newly discovered examples, the techniques can refine the model to handle these cases and similar ones more effectively, leading to overall improvement in performance.

To address the technical challenges of domain dependency and arbitrary parameter selection of the clustering algorithm, the present application introduces a systematic, data-driven approach for estimating the epsilon and min_samples parameters. By reparametrizing epsilon as a percentile of the empirical distribution of pairwise distances within a subset of data points, the method eliminates reliance on manual tuning and arbitrary thresholds. This subset-based estimation not only reduces computational complexity from O(n\hat{ }2) to O(n), enabling efficient processing of large datasets, but also ensures that the clustering process aligns with the similarity structure inherent to the data. Reparametrization further enhances algorithm adaptability by iteratively relaxing density constraints (simultaneously increasing epsilon and decreasing min_samples), allowing the algorithm to identify tightly knit and loosely associated clusters. Through these stepwise adjustments, the reparametrized clustering algorithm becomes inherently adaptive and transferable across diverse domains, effectively discovering clusters that reflect intrinsic relationships within large, heterogeneous natural language datasets.

Further, the present techniques mitigate the adverse effects of high-dimensional embeddings and diverse data distributions by conducting comprehensive hyperparameter tuning across embedding models, dimensionality reduction settings, and the reparametrized algorithm's parameters. The reparametrized, iterative clustering algorithm is trained and validated using comprehensive Text-to-SQL training and validation datasets (e.g., curated from Spider) that include multiple database schemas and associated natural language questions and SQL queries. To ensure that hyperparameter selection optimally reflects various facets of clustering quality, weighted combinations of clustering evaluation metrics are used to assess model performance.

The techniques are additionally enhanced by seeding clustering with labeled in-context examples, which constrains clusters and reduces intent mixing. By varying the proportions of labeled questions included during clustering, the method improves metrics such as homogeneity, completeness, coverage, and intent recall, resulting in more effective identification and curation of in-context examples for NL2SQL models. Seeding may also be performed on testing datasets. For a chosen seeding proportion, a corresponding number of labeled questions from the training set may be added to the unlabeled questions prior to clustering. For instance, at a 20% seeding proportion, the number of labeled questions added equals 20% of the number of unlabeled questions. This procedure enables more effective and precise identification and curation of in-context examples for NL2SQL models.

There are several technical advantages of this solution over prior approaches. The proposed pipeline delivers superior clustering quality compared to the standard and single-iteration variants of DBSCAN. Domain-adaptive, percentile-based parameterization obviates trial-and-error tuning and reduces computational burden, while dimension reduction enhances clustering performance without excessive resource consumption. The empirical assessment of embedding strategies ensures cost-effective model selection, and the seeding mechanism with labeled examples substantially improves clusters and mitigates intent mixing. These features collectively facilitate more efficient and accurate curation workflows, accelerate annotator validation, and support the ongoing improvement of Text-to-SQL systems in dynamic, real-world environments.

### Overview of Clustering Algorithm for Harvesting In-Context Examples

Text-to-SQL input logs are collections of records generated during the operation of NL2SQL systems (e.g., SQL agent system 200 described with respect to FIG. 2), wherein each record includes a natural language question submitted by a user and, optionally, its corresponding programming query language representation such as a structured SQL statement. These logs can be obtained from production environments and capture real-world user interactions with database query interfaces, reflecting both successful and unsuccessful attempts to retrieve information. By analyzing these input logs, NL2SQL models gain access to a comprehensive repository of diverse user queries, facilitating the analysis of user intent, identification of recurring or paraphrased questions, and detection of gaps in model coverage. The present disclosure utilizes these logs as a data source to identify and address deficiencies in NL2SQL models, enabling the dynamic curation and continual refinement of in-context examples that improve model performance and adaptability.

In the context of machine learning and natural language processing, “in-context examples” refer broadly to carefully selected pairs of input data and their corresponding outputs that are presented to a generative model, such as an LLM, during inference or fine-tuning. These examples serve as reference points or demonstrations that guide the model in interpreting and responding to new, unseen user queries. By exposing the model to relevant, concrete instances of how natural language utterances are translated into logical forms (e.g., SQL queries), these examples help the model generalize more effectively and provide accurate outputs in operational environments.

More specifically, within the domain of Text-to-SQL systems, in-context examples may comprise pairs, where a natural language question (e.g., “How many employees were hired in 2022?”) is associated with its corresponding structured query (e.g., “SELECT COUNT (*) FROM employees WHERE hire_date>=‘2022-01-01’ AND hire_date<=‘2022-12-31’”). These pairs are curated to reflect both the linguistic diversity and the specific schema of the target database environment, enabling the NL2SQL model to better map user intent to valid SQL expressions. In the present application, in-context examples are harvested from production logs and may be further enriched with metadata such as user feedback ratings or annotations. The clustering algorithm disclosed herein leverages these logs to identify, group, and curate sets of semantically similar natural language queries and their SQL counterparts, facilitating the dynamic selection and updating of in-context examples. For example, if production logs reveal that users frequently ask variations of “List all active customers,” the system clusters these paraphrased utterances and, by associating them with the correct SQL query, ensures that the most representative and effective in-context examples are available to guide the model's interpretation of future, similarly-expressed queries. In this way, “in-context examples” are not static reference pairs, but dynamically curated, contextually relevant instances that adapt alongside evolving user needs and database schemas, thereby optimizing the accuracy and responsiveness of Text-to-SQL applications. To illustrate this point, below is a simulated example of logged questions before (Table 2) and after (Table 3) clustering.

TABLE 2
Simulated Example Before Clustering

| | Ground | |
|---|---|---|
| | Truth | |
| Question | Example? | SQL |
| Find the names of schools that | TRUE | SELECT T1.School_name, T1.School_id FROM |
| have more than one donator | | School AS T1 JOIN endowment AS T2 ON |
| with donation amount above | | T1.School_id = T2.School_id WHERE T2.amount > |
| 8.5. | | 8.5 GROUP BY T1. School_name, T1.School_id |
| | | HAVING count(*) > 1 |
| Show each county along with | TRUE | SELECT County, count(*), sum(Enrollment) FROM |
| the number of schools and | | School GROUP BY County |
| total enrollment in each | | |
| county. | | |
| Count the number of schools. | TRUE | SELECT count(*) FROM School |
| How many budgets are above | TRUE | SELECT count(*) FROM budget WHERE Budgeted > |
| 3000 in year 2001 or before? | | 3000 AND Year <= 2001 |
| What are the total and average | FALSE | SELECT sum(Enrollment), avg(Enrollment) FROM |
| enrollment of all schools? | | School |
| Count the number of | FALSE | SELECT count(*) FROM budget WHERE Budgeted > |
| budgets in year 2001 or | | 3000 AND Year <= 2001 |
| before whose budgeted | | |
| amount is greater than | | |
| 3000 | | |
| List each donator name and | FALSE | SELECT donator_name, sum(amount) FROM |
| the amount of endowment in | | endowment GROUP BY donator_name ORDER BY |
| descending order of the | | sum(amount) DESC |
| amount of endowment. | | |
| Show the names of | FALSE | SELECT T1.School_name, T1.School_id FROM |
| schools with a total budget | | School AS T1 JOIN budget AS T2 ON T1.School_id = |
| amount greater than 100 | | T2.School_id JOIN endowment AS T3 ON |
| or a total endowment | | T1.School_id = T3.School_id GROUP BY |
| greater than 10. | | T1.School_name, T1.School_id HAVING sum(T2. |
| | | Budgeted) > 100 OR sum(T3.amount) > 10 |
| Find the number of schools | FALSE | SELECT count(*) FROM (SELECT * FROM |
| that have more than one | | endowment WHERE amount > 8.5 GROUP BY |
| donator whose donation | | school_id HAVING count(*) > 1) |
| amount is less than 8.5. | | |
| Show all school names in | FALSE | SELECT School_name FROM School ORDER BY |
| alphabetical order. | | School_name |
| Show the average, maximum, | FALSE | SELECT avg(Enrollment), max(Enrollment), |
| minimum enrollment of all | | min(Enrollment) FROM School |
| schools. | | |
| What are the mascots for | FALSE | SELECT Mascot FROM School WHERE Enrollment > |
| schools with enrollments | | (SELECT avg(Enrollment) FROM School) |
| above the average? | | |
| List the name of the school | FALSE | SELECT School_name FROM School ORDER BY |
| with the smallest enrollment. | | Enrollment LIMIT 1 |
| Show the names of all the | FALSE | SELECT donator_name FROM endowment EXCEPT |
| donors except those whose | | SELECT donator_name FROM endowment WHERE |
| donation amount less than 9. | | amount < 9 |
| List all the names of schools | FALSE | SELECT T1.School_name, T1.School_id FROM |
| with an endowment amount | | School AS T1 JOIN endowment AS T2 ON |
| smaller than or equal to 10. | | T1.School_id = T2.School_id GROUP BY |
| | | T1.School_name, T1. |
| | | School_id HAVING sum(T2.amount) <= 10 |
| List the amount and donor | FALSE | SELECT amount, donator_name FROM endowment |
| name for the largest amount of | | ORDER BY amount DESC LIMIT 1 |
| donation. | | |
| List the names of the schools | FALSE | SELECT School_name FROM School WHERE |
| without any endowment. | | School_id NOT IN (SELECT School_id FROM |
| | | endowment) |
| Show all donor names. | FALSE | SELECT donator_name FROM endowment |
| Show each school name, | FALSE | SELECT T2.School_name, T1.Budgeted, T1.Invested |
| its budgeted amount, and | | FROM budget AS T1 JOIN School AS T2 ON |
| invested amount in year | | T1.School_id = T2.School_id WHERE T1.Year >= |
| 2002 or after. | | 2002 |
| Show the names of donors | FALSE | SELECT T1.donator_name FROM endowment AS T1 |
| who donated to both school | | JOIN School AS T2 ON T1. School_id = T2.School_id |
| “Glenn” and “Triton.” | | WHERE T2.School_name = ‘Glenn’ INTERSECT |
| | | SELECT T1.donator_name FROM endowment AS T1 |
| | | JOIN School AS T2 ON T1. School_id = T2.School_id |
| | | WHERE T2.School_name = ‘Triton’ |
| How many schools are there? | FALSE | SELECT count(*) FROM School |
| What is the total budget | FALSE | SELECT sum(T1.Budgeted) FROM budget AS T1 JOIN |
| amount for school “Glenn” in | | School AS T2 ON T1. School_id = T2.School_id |
| all years? | | WHERE T2.School_name = ‘Glenn’ |
| How many donors have | FALSE | SELECT count(T1.donator_name) FROM |
| endowment for school named | | endowment AS T1 JOIN School AS T2 ON |
| “Glenn”? | | T1.School_id = T2.School_id WHERE |
| | | T2.School_name = ‘Glenn’ |
| List the name, IHSAA Football | FALSE | SELECT T1.School_name, T1.Mascot, |
| Class, and Mascot of the | | T1.IHSAA_Football_Class FROM School AS T1 JOIN |
| schools that have more than | | budget AS T2 ON T1.School_id = T2.School_id |
| 6000 of budgeted amount or | | WHERE T2. |
| were founded before 2003, in | | Budgeted > 6000 OR T2. Year < 2003 ORDER BY T2. |
| the order of percent of total | | total_budget_percent_invested, |
| invested budget and total | | T2.total_budget_percent_budgeted |
| budgeted budget. | | |
| List the name, location, | FALSE | SELECT School_name, Location, Mascot FROM |
| mascot for all schools. | | School |
| How many budget record has | FALSE | SELECT count(*) FROM budget WHERE Budgeted < |
| a budget amount smaller | | ‘invested’ |
| than the invested amount? | | |

TABLE 3
Simulated Example After Clustering

| | | Ground | | |
|---|---|---|---|---|
| | LLB-Generated | Truth | | |
| ID | Summary | Example? | Question | SQL |
| 1 | counting and | FALSE | How many schools are | SELECT count(*) FROM School |
| | analyzing | | there? | |
| | schools, | TRUE | Count the number of | SELECT count(*) FROM School |
| | enrollment, and | | schools. | |
| | distribution by | FALSE | What are the total and | SELECT sum(Enrollment), |
| | county | | average enrollment of | avg(Enrollment) FROM School |
| | | | all schools? | |
| | | FALSE | Show the | SELECT avg(Enrollment), |
| | | | average, | max(Enrollment), min(Enrollment) |
| | | | maximum, | FROM School |
| | | | minimum | |
| | | | enrollment of all | |
| | | | schools. | |
| | | TRUE | Show each county | SELECT County, count(*), |
| | | | along with the number | sum(Enrollment) FROM School |
| | | | of schools and total | GROUP BY County |
| | | | enrollment in each | |
| | | | county. | |
| 2 | budget amounts, | TRUE | How many budgets | SELECT count(*) FROM budget |
| | school | | are above 3000 in | WHERE Budgeted > 3000 AND |
| | information, and | | year 2001 or before? | Year <= 2001 |
| | investment data, | FALSE | Count the number of | SELECT count(*) FROM budget |
| | with queries | | budgets in year 2001 | WHERE Budgeted > 3000 AND |
| | focusing on | | or before whose | Year <= 2001 |
| | filtering, | | budgeted amount is | |
| | counting, and | | greater than 3000 | |
| | summarizing | FALSE | Show each school | T1.School_id = T2.School_id |
| | data based on | | name, its budgeted | SELECT T2.School_name, |
| | various | | amount, and invested | T1.Budgeted, T1.Invested FROM |
| | conditions and | | amount in year 2002 or | budget AS T1 JOIN School AS T2 ON |
| | time frames | | after. | WHERE T1.Year >= 2002 |
| | | FALSE | How many budget | SELECT count(*) FROM budget |
| | | | record has a budget | WHERE Budgeted < ‘invested’ |
| | | | amount smaller than | |
| | | | the invested amount? | |
| | | FALSE | What is the total | SELECT sum(T1.Budgeted) FROM |
| | | | budget amount for | budget AS T1 JOIN School AS T2 |
| | | | school “Glenn” in all | ON T1.School_id = T2.School_id |
| | | | years? | WHERE T2.School_name = ‘Glenn’ |
| | | FALSE | Show the names of | SELECT T1.School_name, |
| | | | schools with a total | T1.School_id FROM School AS T1 |
| | | | budget amount | JOIN budget AS T2 ON |
| | | | greater than 100 or a | T1.School_id = T2.School_id JOIN |
| | | | total endowment | endowment AS T3 ON |
| | | | greater than 10. | T1.School_id = T3.School_id |
| | | | | GROUP BY T1.School_name, |
| | | | | T1.School_id HAVING |
| | | | | sum(T2.Budgeted) > 100 OR |
| | | | | sum(T3.amount) > 10 |
| | | FALSE | List the name, IHSAA | SELECT T1.School_name, |
| | | | Football Class, and | T1.Mascot, |
| | | | Mascot of the | T1.IHSAA_Football_Class FROM |
| | | | schools that have | School AS T1 JOIN budget AS T2 |
| | | | more than 6000 of | ONT1.School_id = T2. School_id |
| | | | budgeted amount or | WHERE T2.Budgeted > 6000 OR |
| | | | were founded before | T2. Year < 2003 ORDER BY |
| | | | 2003, in the order of | T2.total_budget_percent_invested, |
| | | | percent of total | T2. |
| | | | invested budget and | total_budget_percent_budgeted |
| | | | total budgeted | |
| | | | budget. | |
| 3 | listing and | FALSE | Show all school names | SELECT School_name FROM School |
| | comparing | | in alphabetical order. | ORDER BY School_name |
| | school | FALSE | List the name, | SELECT School_name, Location, |
| | information | | location, mascot for all | Mascot FROM School |
| | such as names, | | schools. | |
| | locations, | FALSE | What are the | SELECT Mascot FROM School |
| | mascots, | | mascots for | WHERE Enrollment > (SELECT |
| | enrollments, | | schools with | avg(Enrollment) FROM School) |
| | and | | enrollments | |
| | endowments | | above the | |
| | | | average? | |
| | | FALSE | List the name of the | SELECT School_name FROM |
| | | | school with the | School ORDER BY Enrollment |
| | | | smallest enrollment. | LIMIT 1 |
| | | FALSE | List the names of the | SELECT School_name FROM School |
| | | | schools without any | WHERE School_id NOT IN (SELECT |
| | | | endowment. | School_id FROM endowment) |
| | | FALSE | List all the names of | SELECT T1.School_name, |
| | | | schools with an | T1.School_id FROM School AS T1 |
| | | | endowment amount | JOIN endowment AS T2 ON |
| | | | smaller than or equal | T1.School_id = T2.School_id |
| | | | to 10. | GROUP BY T1.School_name, |
| | | | | T1.School_id HAVING |
| | | | | sum(T2.amount) <= 10 |
| 4 | donor | FALSE | How many donors | SELECT count(T1.donator_name) |
| | information, | | have endowment for | FROM endowment AS T1 JOIN |
| | endowment | | school named | School AS T2 ON T1.School_id = |
| | amounts, | | “Glenn”? | T2.School_id WHERE T2. |
| | and school | | | School_name = ‘Glenn’ |
| | names, | FALSE | List each donator | SELECT donator_name, |
| | focusing on | | name and the | sum(amount) FROM endowment |
| | filtering, | | amount of | GROUP BY donator_name ORDER |
| | sorting, and | | endowment in | BY sum(amount) DESC |
| | aggregating | | descending order of | |
| | donation | | the amount of | |
| | data | | endowment. | |
| | | FALSE | Show the names of | SELECT T1.donator_name FROM |
| | | | donors who donated | endowment AS T1 JOIN School AS |
| | | | to both school | T2 ONT1.School_id = T2.School_id |
| | | | “Glenn” and “Triton.” | WHERE T2.School_name |
| | | | | = ‘Glenn’ INTERSECT SELECT |
| | | | | T1.donator_name FROM |
| | | | | endowment AS T1 JOIN School AS |
| | | | | T2 ONT1.School_id = T2. School_id |
| | | | | WHERE T2.School_name = ‘Triton’ |
| | | FALSE | Show the names of all | SELECT donator_name FROM |
| | | | the donors except | endowment EXCEPT SELECT |
| | | | those whose donation | donator_name FROM endowment |
| | | | amount less than 9. | WHERE amount < 9 |
| | | FALSE | List the amount and | SELECT amount, donator_name |
| | | | donor name for the | FROM endowment ORDER BY |
| | | | largest amount of | amount DESC LIMIT 1 |
| | | | donation. | |
| | | FALSE | Show all donor names. | SELECT donator_name FROM |
| | | | | endowment |
| | | TRUE | Find the names of | SELECT T1.School_name, |
| | | | schools that have | T1.School_id FROM School AS T1 |
| | | | more than one | JOIN endowment AS T2 ON |
| | | | donator with donation | T1.School_id = T2.School_id |
| | | | amount above 8.5. | WHERE T2.amount > 8.5 GROUP |
| | | | | BY T1.School_name, T1.School_id |
| | | | | HAVING count(*) > 1 |
| | | FALSE | Find the number of | SELECT count(*) FROM (SELECT * |
| | | | schools that have | FROM endowment WHERE amount |
| | | | more than one | > 8.5 GROUP BY school_id HAVING |
| | | | donator whose | count(*) > 1) |
| | | | donation amount is | |
| | | | less than 8.5. | |

As can be appreciated from the above demo, the inclusion of current in-context examples (e.g., “Is Ground-truth Example?”=TRUE), alongside logged questions prior to clustering, can enhance the annotation workflow by providing reliable reference points for labeling and validation. In-context examples, identified in the logs and accompanied by their corresponding gold SQL statements, assist annotators in accurately labeling clustered log data and improve the quality of clustering for the logged questions. For instance, when a question such as “How many schools are there?” appears in the logs as a paraphrase of the established in-context example “Count the number of schools,” its addition to the in-context example set may strengthen the model's ability to handle varied user expressions. The annotation process is further facilitated by cluster-level summaries generated from grouped questions using large language models (LLMs), which help annotators efficiently navigate and prioritize which clusters to review. Additionally, ratings information embedded in Text-to-SQL logs, such as thumbs up and thumbs down votes, may be leveraged during curation. Clusters exhibiting a high number of negative ratings may be prioritized for review, as these likely indicate areas where the current model underperforms or fails to meet user expectations. In contrast, clusters with predominantly positive ratings serve as validation signals, allowing annotators to expedite acceptance and reuse of these clusters with minimal additional review.

Clusters that contain both paraphrased versions of existing in-context examples and questions expressing new information needs are particularly valuable for improving model robustness. Questions such as “What are the total and average enrollment of all schools?” and “Show the average, maximum, minimum enrollment of all schools?” represent new information needs not addressed by the current in-context example set. Incorporating such questions into the set supports continuous expansion and refinement, increasing the likelihood that the model responds correctly to similar future queries. This iterative process, in which both paraphrases and new information needs are added to the in-context example set, ensures that the Text-to-SQL system remains responsive to a broad and evolving range of user queries.

To facilitate the harvesting and curation of in-context examples from Text-to-SQL logs as described above, the standard DBSCAN clustering algorithm is enhanced with three key modifications. The first modification includes using a data-driven approach to estimate the local radius parameter (epsilon), eliminating the need for tedious trial-and-error parameter tuning. The second modification involves hyperparameter tuning across a diverse range of Text-to-SQL domains to derive generalized parameter values. This approach substantially reduces the time spent by end-users to tune clustering parameters when applying the method to a new domain. The third modification is to seed the clustering process with a small set of labeled existing in-context examples.

### Reparameterization of the Clustering Algorithm

As described herein, reparameterization of an algorithm refers to altering or redefining the way parameters of the algorithm are selected, estimated, or controlled. This process involves shifting from static, manually chosen values to dynamic, data-driven, or adaptive methods. Reparameterization typically aims to improve the algorithm's flexibility, robustness, and generalizability across diverse datasets by systematically tying parameter values to empirical characteristics of the data being processed, rather than relying on fixed or arbitrary settings. In the context of clustering algorithms such as DBSCAN (Density-Based Spatial Clustering of Applications with Noise), reparameterization involves moving away from manually selecting critical parameters, such as the neighborhood radius (epsilon) and the minimum cluster size (min_samples), and instead determining these values algorithmically based on the observed statistical properties of the data, such as the distribution of pairwise distances among data points.

By way of example, reparameterization of the clustering algorithm described herein involves estimating and iteratively adjusting the clustering parameters for the algorithm using empirical measurements derived from the actual text embedding vectors representing natural language utterances in Text-to-SQL logs. Rather than setting the epsilon and min_samples parameters through trial-and-error or domain heuristics, the system computes these values directly from distance percentiles calculated on sampled subsets of the data. This data-driven approach enables the clustering algorithm to dynamically adapt to the underlying structure and density variations present in real-world query logs, thereby enhancing its ability to identify both tightly grouped paraphrases and more loosely related question clusters without extensive manual intervention.

To estimate the local radius parameter (epsilon), the process begins by sampling a subset of data points from a full dataset for use in empirical distance computations. The sampling of this subset may be performed according to any of a variety of techniques, each of which is contemplated as being within the scope of the present disclosure. In some embodiments, the sampling may be performed randomly, wherein a predetermined or dynamically determined number of data points are selected at random from the total population of data points. In other embodiments, stratified sampling may be employed, whereby the dataset is divided into strata or groups based on one or more characteristics (such as label distributions, query lengths, or metadata categories), and data points are sampled from each stratum to ensure representative coverage. In yet other embodiments, systematic sampling may be utilized, for example by selecting every nth data point from an ordered list or sequence. The sampling may also be adaptive or weighted, such that data points are selected with probabilities proportional to specified criteria, such as frequency of occurrence, user feedback ratings, or prior clustering outcomes. Additionally, the sampling process may be governed by user input, predefined policies, heuristics, or optimization objectives relevant to clustering performance or computational efficiency. In certain scenarios, multiple sampling strategies may be combined, or the sampling method may be changed dynamically based on interim results or system resource constraints. The chosen sampling technique may be implemented to balance trade-offs among computational efficiency, representativeness of the subset, and the particular goals of the clustering operation.

After the sampling subset has been determined as described above, the process continues by computing the distances from each sampled data point to all other points in the dataset. In some instances, each sample point is a vector representation of a text-to-SQL record (e.g., a natural language utterance and optionally its corresponding SQL) from the Text-to-SQL logs described above. On the sampled subset of data points, the clustering algorithm measures the similarity or dissimilarity among these vectors by calculating pairwise distances. These distances may be ordered from closest to farthest for each sampled data point, and analyzed to determine an initial value, a final value, and an iteration value for the neighborhood radius parameter (e.g., epsilon parameter). For every data point in the subset, the distance to its closest neighbor, as well as the distance to the next-closest neighbor, are identified. This results in two distinct sets of neighbor distances, one corresponding to the closest neighbors and the other to the next-closest. These sets are statistically examined to determine threshold values that inform the selection of the epsilon parameter.

The initial value of epsilon (INITIAL_EPS) is set to a low percentile, for example, a percentile corresponding to a value that is smaller than 95% of the other distances, to enable strict clustering at the outset. The final value of epsilon (LAST_EPS) is set to a higher percentile, for example, a value that is greater than 95% of the other distances, to allow for more relaxed clustering in subsequent iterations. Accordingly, the low percentile value establishes the starting threshold for considering whether two examples are sufficiently similar to be considered neighbors, while the high percentile value defines the upper bound for similarity as the algorithm progresses. The difference between the initial value and the final value is divided across the number of clustering iterations to calculate the iteration value (DELTA_EPS), which constitutes the step size for relaxing epsilon in each iteration. This stepwise approach to adjusting epsilon ensures that the clustering process transitions from a strict regime, where only tightly similar examples are grouped, to a more relaxed regime, where examples with broader similarity may be clustered together.

In conjunction with estimating the values for the epsilon parameter, the process also adjusts the min_samples parameter, which specifies the minimum number of neighbors required to form a cluster, as the clustering iterations proceed. This adjustment involves determining the largest and smallest values for min_samples that will be used during clustering and calculating the incremental change (delta_min_sample) by which this parameter will decrease over successive iterations.

To determine appropriate values for min_samples, the algorithm computes distance distributions for each sampled point's k nearest neighbors using both the smallest_min_sample and largest_min_sample values. For the smallest_min_sample, the algorithm examines the set of nearest neighbors for each sampled point, considering only as many neighbors as defined by the smallest_min_sample parameter. For the largest_min_sample, the algorithm expands this set to include the number of neighbors specified by the largest_min_sample parameter. The values for smallest_min_sample and largest_min_sample may be selected automatically by the system or may be explicitly provided by the user. Furthermore, these parameters may be hyper-tuned as part of the hyper-tuning process described below. By utilizing these parameter values, the algorithm can analyze how the data's neighborhood structure varies with different clustering requirements. In this way, the algorithm assesses the impact of imposing stricter (larger min_samples) or more relaxed (smaller min_samples) clustering conditions. The incremental change, delta_min_sample, is calculated as the amount by which the min_samples parameter will be reduced at each iteration, allowing the clustering process to transition smoothly from initially requiring more neighbors to form a cluster to eventually allowing clusters to form with fewer neighbors. This method enables the identification of both tightly knit and more loosely associated groups of data points, thereby adapting the clustering process to capture relationships within the dataset at multiple levels of detail.

During the clustering process, the algorithm performs multiple iterations, refining its identification of semantically similar groupings within the dataset. In each iteration, the clustering algorithm is applied to the subset of data points that have not yet been clustered, utilizing the current epsilon and min_samples values. Following the completion of each iteration, those data points that have been successfully assigned to a cluster are collected and removed from the pool of un-clustered points, thereby ensuring that subsequent iterations focus exclusively on the remaining data. At the start of each new iteration, the epsilon parameter is incrementally increased, and the minimum cluster size parameter (min_samples) is decreased in accordance with the predetermined schedule. This iterative adjustment allows the clustering process to first capture the largest clusters with similar questions (e.g., large, tight clusters), and then include smaller clusters with less strictly related questions (e.g., small, loose clusters).

In some embodiments, the hyperparameter tuning process is performed in multiple tuning stages that mirror the iterative clustering passes, and the tuning dataset is updated between stages by removing data points that have already been clustered. For example, for a given candidate configuration (e.g., embedding model, reduction settings, LOWEST_DISTANCE_PERCENTILE/HIGHEST_DISTANCE_PERCENTILE, and a range for min_samples), the system executes an initial clustering iteration on a tuning dataset using strict density constraints (e.g., relatively small epsilon and relatively large min_samples) and then removes the clustered data points from the vector representations (e.g., by excluding those vectors from the dataset) to form a residual set of un-clustered data points. The system then performs a subsequent iteration of hyperparameter tuning using only the residual un-clustered data points, for instance by re-evaluating candidate epsilon percentiles and min_samples values to optimize a weighted combination of clustering metrics on the residual set, and repeating this stage-wise procedure until a stopping criterion is met (e.g., a fixed number of stages or when remaining un-clustered points fall below a threshold). By way of example and not limitation, when tuning on a schema-specific tuning set of 10,000 vector representations, a first iteration may cluster and remove 6,500 points under strict settings, and a second iteration may be performed on the remaining 3,500 un-clustered points to select more relaxed parameters (e.g., increased epsilon and decreased min_samples) that better capture smaller, looser clusters, thereby producing hyperparameters that are explicitly optimized across successive residuals rather than being fit only to the initially densest regions of the dataset.

Once all specified iterations are complete, the algorithm returns the comprehensive set of clustered data points. These clusters represent groups of semantically similar queries, paraphrased questions (i.e., paraphrases of the in-context examples), or new information needs (i.e., new in-context examples corresponding to distinct SQL queries) extracted from the input logs. When a cluster corresponds to an existing in-context example, the process may add one or more of the paraphrased queries to the dataset to enhance its linguistic robustness. Additionally, if a cluster is identified as novel and does not match existing examples, the process may add one or more of the new question-SQL pairs as in-context examples, thus expanding coverage and addressing new information needs.

This reparameterization method makes the clustering process both adaptive and data driven. By basing the selection and adjustment of the epsilon parameter on actual measurements of similarity among the data, rather than on arbitrary or static thresholds, the reparametrized clustering algorithm can discover clusters that reflect the intrinsic structure of the data. This is particularly advantageous when processing large volumes of natural language data, where the optimal parameterization for similarity is not readily apparent. This also makes the reparametrized clustering algorithm more transferable across different domain types.

Provided below is an exemplary pseudo code for the re-parameterization of the iterative DBSCAN algorithm. The pseudo code provided below is merely an example of pseudo code that may be used to re-parameterize the parameters of the standard SB-SCAN clustering algorithm and is not intended to unduly limit the scope of claimed embodiments. One of ordinary skill in the art would recognize many possible variations, alternatives, and modifications, may be bade to the pseudo code.

Exemplary Pseudo Code for the Re-parameterized Iterative DBSCAN Algorithm

```
def Run_Iterative_DB_SCAN(data_embeddings, INITIAL_EPS, DELTA_EPS,
SMALLEST_MIN_SAMPLES, LARGEST_MIN_SAMPLES, DELTA_MIN_SAMPLES):
    eps = INITIAL_EPS
  data_embeddings_to_cluster = data_embeddings all_clustered_data = [ ]
  LOOP min_samples from LARGEST_MIN_SAMPLES to SMALLEST_MIN_SAMPLES with a
decrease step size DELTA_MIN_SAMPLES :
      # DBSCAN does not cluster all data points in data_embeddings_to_cluster
      # We only collect those points that are clustered by DBSCAN
    clustered_data = Run_DBSCAN(data_embeddings_to_cluster, eps=eps,
min_samples=min_samples)
      # Add these new clustered data points to the final result
    all_clustered_data.extend(clustered_data)
      # Remove the newly clustered data from the current set of data to cluster.
      # In the next iteration, we only cluster those left-over data points.
    data_embeddings_to_cluster = data_embeddings_to_cluster \ clustered_data
      # At each iteration, we relax both min_samples and eps parameters
    eps = eps + DELTA_EPS RETURN all_clustered_data
def SELECT_DISTANCE_SUBSET_PER_SAMPLED_POINT(sampled_data_embeddings,
sampled_distances, TOP_SMALLEST_DISTANCES):
  # The function SELECT_DISTANCE_SUBSET_PER_SAMPLED_POINT loops over each data
point in sampled_data_embeddings,
    # sort its distances to all other points from lowest to largest, then return the
TOP_SMALLEST_DISTANCES
def Run_Reparametrize_Iterative_DB_SCAN(data_embeddings, DISTANCE_SAMPLE_SIZE,
LOWEST_DISTANCE_PERCENTILE, HIGHEST_DISTANCE_PERCENTILE,
SMALLEST_MIN_SAMPLES, LARGEST_MIN_SAMPLES, DELTA_MIN_SAMPLES):
    # (I) Estimate INITIAL_EPS and DELTA_EPS
  sampled_data_embeddings = SAMPLE_POINTS(DISTANCE_SAMPLE_SIZE,
data_embeddings)
  # We only consider distances from each sampled point to all data points.
  # This sampling step reduces the distance computation's complexity from O(N\hat{ }2) to
O(N)
    sampled_distances = COMPUTE_PAIRWISE_DISTANCES
(sampled_data_embeddings, data_embeddings)
    # We get the distribution of distances from each sampled points to its
SMALLEST_MIN_SAMPLES closest neighbors
    smallest_min_samples_distances =
SELECT_DISTANCE_SUBSET_PER_SAMPLED_POINT(sampled_data_embeddings,
sampled_distances, TOP_SMALLEST_DISTANCES=SMALLEST_MIN_SAMPLES)
    # We then get the most relaxing ESP that will be run with min_samples =
SMALLEST_MIN_SAMPLES LAST_EPS =
smallest_min_samples_distances.quantile(HIGHEST_DISTANCE_PERCENTILE)
    # We get the distribution of distances from each sampled points to its
LARGEST_MIN_SAMPLES closest neighbours
    largest_min_samples_distances =
SELECT_DISTANCE_SUBSET_PER_SAMPLED_POINT(sampled_data_embeddings,
sampled_distances, TOP_SMALLEST_DISTANCES=LARGEST_MIN_SAMPLES)
    # The then get the most restricted EPS that will be run with min_samples =
LARGEST_MIN_SAMPLES
    # We include an operator min with
smallest_min_samples_distances.quantile(LOWEST_DISTANCE_PERCENTILE)
    # to make sure that LAST_EPS > INITIAL_EPS
    INITIAL_EPS = min(
      largest_min_samples_distances.quantile
(LOWEST_DISTANCE_PERCENTILE),
        smallest_min_samples_distances.quantile
(LOWEST_DISTANCE_PERCENTILE),
)
    # We work out the DELTA_EPS in each iteration that is required with INITIAL_EPS
in the function Run_Iterative_DB_SCAN
  NUMBER_OF_ITERATIONS = 1 + (LARGEST_MIN_SAMPLES − SMALLEST_MIN_SAMPLES) /
DELTA_MIN_SAMPLES
  DELTA_EPS = (LAST_EPS − INITIAL_EPS) / NUMBER_OF_ITERATIONS
  # (II) Run the iterative DBSCAN with INITIAL_EPS and DELTA_EPS empirically estimated
from data points all_clustered_data = Run_Iterative_DB_SCAN(data_embeddings, INITIAL_EPS,
DELTA_EPS, SMALLEST_MIN_SAMPLES,
LARGEST_MIN_SAMPLES, DELTA_MIN_SAMPLES)
  RETURN all_clustered_data
```

### Hyperparameter Tuning for High-Dimensional Text Embeddings

Hyperparameter tuning for high-dimensional text embeddings includes a systematic and iterative process aimed at optimizing the performance of the reparametrized clustering algorithm on text-based datasets. The process involves adjusting and selecting parameters related to the embedding models, dimensionality reduction methods, and the reparametrized clustering algorithm itself to enhance clustering outcomes based on predefined performance metrics.

Initially, the text-based data, e.g., the SQL production logs, are transformed into dense, high-dimensional vectors by natural language embedding models. The selection and configuration of the embedding model may be guided by the need to capture meaningful contextual and linguistic relationships, with further customization available through adjustments to tokenization strategies, fine-tuning on domain-specific corpora, or modification of loss functions. The effectiveness of an embedding model is assessed using a set of clustering performance metrics, which may include homogeneity, completeness, v-measure, data coverage, and intent recall. By way of example, embedding models such as MUSE, ConveRT, or combinations thereof, may be selected. The performance of each configuration is evaluated using the aforementioned metrics, ensuring the reparametrized clustering algorithm yields coherent and interpretable groupings.

When working in the high-dimensional vector space, the quality of clusters generated by the clustering algorithm can degrade as distance metrics lose discriminative power and clusters become less distinguishable with increasing dimensions. To address this problem, dimensionality reduction algorithms, such as UMAP or PCA, may be used to improve clustering quality by preserving the discriminative power of distance metrics and enhancing cluster separation. The choice and configuration of dimensionality reduction algorithms are likewise guided by clustering performance metrics.

Once the text embedding model and dimensional reduction algorithm are selected, the next step is to perform hyperparameter tuning on the parameters (e.g., epsilon and min_samples) of the reparametrized clustering algorithm. The objective for hyper-tuning is to determine parameter values that generalize well across various domain spaces, thereby minimizing the need for domain-specific adjustments and facilitating deployment in new domains. The training and validation techniques used for hyperparameter tuning of the reparametrized clustering algorithm may be similar to, substantially similar to, or identical to the training and validation techniques described with respect to FIG. 4. Candidate hyperparameter configurations may include testing ranges of minimum cluster sizes (e.g., 3, 4, 5) and lower/upper distance percentiles for epsilon estimation (e.g., from 0.01 to 0.99). These configurations may be evaluated in conjunction with the different embedding models (such as MUSE, ConveRT, or their concatenation) and dimensional reduction methods (such as UMAP or PCA) at various output dimensions (e.g., 384, 256, 128, 64, 32). The comprehensive set of performance metrics (e.g., homogeneity, completeness, v-measure, data coverage, intent recall, and an equally weighted composite metric (EW 4)) is used to assess each candidate configuration.

Hyperparameter tuning is performed on the reparametrized clustering algorithm by performing iterative operations, where the parameters are adjusted incrementally and clustering performance is evaluated at each step. The process may begin with a labeled training dataset to tune parameters, followed by validation on a separate dataset to confirm the generalizability of the selected parameters. The goal is to identify default parameter values that perform robustly across a variety of domain spaces, thereby facilitating application to new datasets with minimal additional tuning.

The datasets used for training and validating embedding, dimensionality reduction, and clustering algorithms may be derived from a comprehensive Text-to-SQL corpus. Such datasets typically contain paired natural language queries and corresponding SQL statements spanning hundreds of database schemas across many different domains. The queries are designed to elicit a range of SQL operations, encompassing simple queries as well as those involving multi-table joins, aggregation, nested subqueries, and conditional logic. The linguistic diversity of the queries may further promote robustness in handling paraphrasing, ambiguity, and varied syntactic structures. To generate the training and validation dataset, various data splitting techniques may be applied to the Text-to-SQL dataset including but not limited to a simple random split (e.g., a 70/30%, 80/20%, or 60/40%), stratified sampling, k-fold cross-validation, and the like.

Seeding the Clustering Process with Existing In-Context Examples

Seeding with existing in-context examples involves integrating a selected subset of labeled ground truth examples into the pool of unlabeled production logs prior to executing the clustering algorithm. The existing in-context examples may originate from a variety of sources, including but not limited to: (i) previously validated pairs of natural language utterances and their corresponding logical forms or SQL queries curated by subject matter experts, (ii) “golden” or ground truth datasets assembled during prior annotation efforts or system training, (iii) examples that have been empirically confirmed to yield correct and intended results when processed by the NL2SQL system, or (iv) reference examples accumulated from historical production logs that have been positively rated or otherwise validated by user feedback mechanisms. Such in-context examples may represent canonical or archetypal question-query pairs that have undergone manual review, automated quality checks, or a combination thereof, ensuring their correctness, reliability, and suitability for use as reference standards during the clustering and curation process.

To seed the pool of production log in-context examples (e.g., unlabeled examples), an appropriate proportion of the existing in-context examples (e.g., labeled) is determined and added to or used to augment with the pool of production log in-context examples before executing the clustering algorithm. The proportion of labeled to unlabeled data may be varied within a range, such as 20% to 200%, to optimize clustering outcomes across diverse application contexts. As used herein, the phrase “within a range of X % to Y %” or “between X % and Y %” refers to values that include and encompass both X % and Y % as well as all values therebetween. For example, within a range of 20% to 200% is intended to include both 20% and 200% as endpoints, and all intermediate values from 20% up to and including 200%, unless expressly stated otherwise.

The seeding proportion may be adapted to accommodate different types of labeled examples, including domain-specific question pairs, annotated log entries, or other curated reference items, thereby facilitating applicability in a wide array of domains. Further, determination of the seeding proportion may be accomplished according to any of a variety of techniques, each of which is contemplated as being within the scope of the present disclosure. In some embodiments, the seeding proportion may be set as a fixed percentage of the unlabeled data, such as a predetermined ratio (e.g., 20%, 50%, 100%, or 200%) based on empirical studies, heuristic rules, or historical performance data. In other embodiments, the seeding proportion may be dynamically adjusted in response to interim clustering outcomes, such as cluster purity, coverage metrics, or the observed diversity of the underlying dataset. The seeding proportion may also be determined based on resource constraints, such as available computational capacity, annotation budget, or the volume of high confidence labeled examples at hand. Additionally, the seeding proportion may be user-configurable, set by system administrators or subject matter experts according to application-specific objectives or policy considerations. In some cases, adaptive algorithms may be employed to iteratively refine the seeding proportion, for example by incrementally increasing or decreasing the proportion in response to real-time feedback, model validation results, or predefined optimization criteria. The seeding proportion may further be determined differently across domains, database schemas, or operational environments to account for domain heterogeneity, class imbalance, or the criticality of certain intents. Any combination of the foregoing approaches may be utilized, and the method of determining the seeding proportion may be revised or re-optimized over time as additional empirical evidence or operational requirements dictate.

Once added, clustering is performed across the augmented dataset, with performance evaluation conducted exclusively on clusters formed from the unlabeled examples. The labeled items are excluded from metric computation to ensure an unbiased assessment of clustering quality. Evaluation metrics such as homogeneity, completeness, v-measure, data coverage, and intent recall are then calculated using only the clusters originating from the unlabeled data, thereby enabling a consistent assessment of cluster quality and intent separation across varying domains.

### EXAMPLES

The following examples are provided by way of illustration only and not by way of limitation. Those of skill in the art will readily recognize a variety of non-critical parameters that could be changed or modified to yield essentially the same or similar results.

### Evaluation Metrics

During experimental evaluations, clustering results were assessed using several key performance metrics including: homogeneity, completeness, v-measure, data coverage, intent recall, and EW 4 Criteria. Homogeneity measured the extent to which each cluster contained only questions of the same gold SQL group, with values closer to 1.0 indicating higher purity and consequently greater annotator throughput. Completeness evaluated whether all questions of the same gold SQL group were assigned to the same cluster. A completeness score of 1.0 indicated that all questions of the same gold SQL were grouped together in the same cluster, while a completeness score of 0.5 indicated that each gold SQL group was, on average, divided into two clusters. Clusters having a larger size (e.g., 10 questions as opposed to 3 questions in a single cluster) provided stronger support for introducing a new SQL not already represented among the existing in-context examples. V-measure is an aggregate metric that evaluates the quality of clustering by combining both the homogeneity and completeness scores into a single value. V-measure is calculated in such a way that it reflects the balance between these two metrics: it will be high when both homogeneity and completeness are high. In other words, V-measure rewards clustering solutions that keep similar items together and ensure that each true group is not split across multiple clusters. If either homogeneity or completeness is low, the V-measure will also be low, thereby indicating a deficiency in the clustering results. Data coverage represented the proportion of questions that were successfully assigned to clusters. Intent recall quantified the proportion of gold SQLs identified by the clustering algorithm. A high intent recall indicated the clustering algorithm detected novel information needs. The EW 4 Criteria metric combined homogeneity, completeness, data coverage, and intent recall to optimize hyperparameter tuning and assess clustering quality across multiple dimensions.

### Methods

The experiments utilized the Spider training set for comparative analyses of the re-parameterized iterative DBSCAN clustering algorithm, text embedding models, and dimension reduction techniques. The Spider training set comprised 136 database schemas, each containing between 20 and 100 pairs of natural language questions and SQL statements (see Table 4), while the Spider validation set included 20 schemas with 20 and 80 pairs per schema (see Table 5).

TABLE 4
Training DB Schema Set:

| | No. of |
|---|---|
| DB Schema | Examples |
| activity_1 | 88 |
| aircraft | 46 |
| allergy_1 | 98 |
| apartment_rentals | 80 |
| architecture | 17 |
| assets_maintenance | 31 |
| behavior_monitoring | 40 |
| bike_1 | 104 |
| body_builder | 24 |
| book_2 | 21 |
| browser_web | 18 |
| candidate_poll | 40 |
| chinook_1 | 84 |
| cinema | 30 |
| city_record | 40 |
| climbing | 40 |
| club_1 | 70 |
| coffee_shop | 18 |
| college_1 | 164 |
| college_2 | 170 |
| college_3 | 74 |
| company_1 | 7 |
| company_employee | 16 |
| company_office | 40 |
| county_public_safety | 40 |
| cre_Doc_Control_Systems | 33 |
| cre_Doc_Tracking_DB | 90 |
| cre_Docs_and_Epenses | 84 |
| cre_Drama_Workshop_Groups | 82 |
| cre_Theme_park | 84 |
| csu_1 | 70 |
| culture_company | 38 |
| customer_complaints | 46 |
| customer_deliveries | 16 |
| customers_and_addresses | 88 |
| customers_and_invoices | 82 |
| customers_and_products_contacts | 15 |
| customers_campaigns_ecommerce | 15 |
| customers_card_transactions | 80 |
| debate | 15 |
| decoration_competition | 15 |
| department_management | 16 |
| department_store | 88 |
| device | 40 |
| document_management | 44 |
| dorm_1 | 100 |
| driving_school | 93 |
| e_government | 40 |
| e_learning | 82 |
| election | 68 |
| election_representative | 20 |
| entertainment_awards | 22 |
| entrepreneur | 40 |
| epinions_1 | 30 |
| farm | 40 |
| film_rank | 48 |
| flight_1 | 96 |
| flight_4 | 82 |
| flight_company | 19 |
| formula_1 | 80 |
| game_1 | 86 |
| game_injury | 19 |
| gas_company | 46 |
| gymnast | 40 |
| hospital_1 | 100 |
| hr_1 | 124 |
| icfp_1 | 66 |
| inn_1 | 74 |
| insurance_and_eClaims | 40 |
| insurance_fnol | 42 |
| insurance_policies | 48 |
| journal_committee | 18 |
| local_govt_and_lot | 17 |
| local_govt_in_alabama | 15 |
| local_govt_mdm | 14 |
| machine_repair | 30 |
| manufactory_1 | 80 |
| manufacturer | 16 |
| match_season | 58 |
| medicine_enzyme_interaction | 44 |
| mountain_photos | 17 |
| movie_1 | 98 |
| music_1 | 100 |
| music_2 | 100 |
| music_4 | 60 |
| musical | 40 |
| network_2 | 86 |
| news_report | 18 |
| party_host | 30 |
| party_people | 44 |
| performance_attendance | 15 |
| perpetrator | 21 |
| phone_1 | 29 |
| phone_market | 15 |
| pilot_record | 15 |
| product_catalog | 42 |
| products_for_hire | 18 |
| products_gen_characteristics | 86 |
| program_share | 40 |
| protein_institute | 20 |
| race_track | 42 |
| railway | 21 |
| restaurant_1 | 22 |
| riding_club | 17 |
| roller_coaster | 17 |
| school_bus | 18 |
| school_finance | 26 |
| school_player | 40 |
| scientist_1 | 48 |
| ship_1 | 48 |
| ship_mission | 30 |
| shop_membership | 44 |
| small_bank_1 | 50 |
| soccer_1 | 14 |
| soccer_2 | 106 |
| solvency_ii | 15 |
| sports_competition | 52 |
| station_weather | 16 |
| store_1 | 112 |
| storm_record | 44 |
| student_1 | 68 |
| student_assessment | 53 |
| swimming | 30 |
| theme_gallery | 40 |
| tracking_grants_for_research | 78 |
| tracking_orders | 60 |
| tracking_share_transactions | 41 |
| tracking_software_problems | 48 |
| train_station | 23 |
| twitter_1 | 27 |
| university_basketball | 46 |
| voter_2 | 72 |
| wedding | 20 |
| wine_1 | 82 |
| workshop_paper | 30 |
| wrestler | 40 |

TABLE 5
Validation DB Schema Set:

| DB Schema | No. of Examples | DB Schema | No. of Examples |
|---|---|---|---|
| battle_death | 16 | orchestra | 40 |
| car_1 | 92 | pets_1 | 42 |
| concert_singer | 45 | poker_player | 40 |
| course_teach | 30 | real_estate_properties | 4 |
| cre_Doc_Template_Mgt | 84 | singer | 30 |
| dog_kennels | 82 | student_transcripts_tracking | 78 |
| employee_hire_evaluation | 38 | tvshow | 62 |
| flight_2 | 80 | voter_1 | 15 |
| museum_visit | 18 | world_1 | 120 |
| network_1 | 56 | wta_1 | 62 |

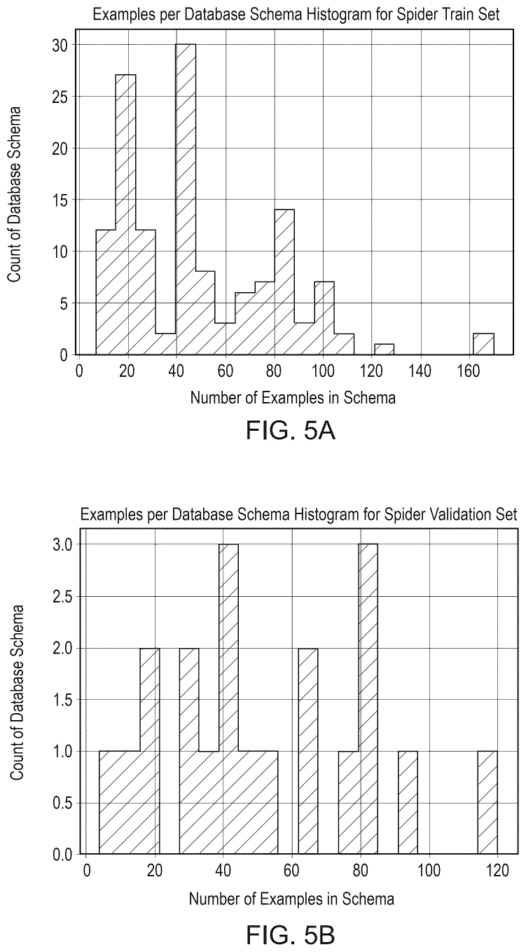

Additionally, the distribution of examples across various database schemas for the Spider training set and the Spider validation set are also displayed as histograms in FIGS. 5A and 5B. Each bar represents the frequency of database schemas that contain a particular number of examples. The x-axis displays the range of example counts within each schema, while the y-axis indicates how many schemas correspond to each example count. As can be observed, for both the training and validation sets, most gold SQLs only have 1 or 2 question variations. In other words, most of the gold SQL groups only have 1 or 2 examples (see Tables 6 and 7 below).

TABLE 6
Cluster sizes in the Spider Training Set

| Cluster Size | Count |
|---|---|
| 1 | 1,518 |
| 2 | 2,528 |
| 3 | 9 |
| 4 | 21 |
| 6 | 1 |
| 8 | 1 |
| 13 | 1 |

TABLE 7
Cluster sizes in the Spider Validation Set

| Cluster Size | Count |
|---|---|
| 1 | 137 |
| 2 | 441 |
| 3 | 1 |
| 4 | 3 |

The Spider training set was used for both clustering performance comparisons and hyperparameter tuning, and the Spider validation set was reserved for evaluating the tuned parameters. As described below, the results demonstrated that the proposed pipeline achieved substantial improvements in clustering quality metrics, with enhanced homogeneity, completeness, v-measure, data coverage, and intent recall across diverse schemas and experimental conditions.

### Example 1: DBSCAN Versus Re-Parameterized Iterative DBSCAN

During experimental evaluations, the performance of the original DBSCAN algorithm was compared to the re-parameterized iterative DBSCAN algorithm using the Spider train set. The text embedding model MUSE was used. Additionally, default parameters (i.e., not fine-tuned) were used for all clustering algorithms. Each clustering algorithm was run independently on each of the database schemas, and performance metrics were averaged across the schemas to provide a comprehensive assessment.

A comparative performance of the algorithms across all metrics is shown in Table 8. The results demonstrated that the re-parameterized DBSCAN algorithm outperformed the original DBSCAN algorithm in both homogeneity and completeness, indicating that the data-driven re-parameterization of the eps parameter and the use of domain-specific distance estimation improved the purity and coverage of clusters. While minor declines were observed in data coverage and intent recall relative to the original DBSCAN algorithm, these were offset by the notable improvements in the homogeneity and completeness. The iterative clustering steps were shown to recover reductions in data coverage and intent recall that occurred in the single-iteration re-parameterized DBSCAN algorithm, resulting in a balanced trade-off between clustering quality and breadth of coverage.

TABLE 8

| | | Re-parameterized DBSCAN | Re-parameterized Iterative DBSCAN |
|---|---|---|---|
| | DBSCAN | Algorithm | Algorithm |
| Metric | Algorithm | (1 iteration) | (5 iterations) |
| homogeneity | 0.041 | 0.315 | 0.356 |
| completeness | 0.852 | 0.936 | 0.957 |
| v_measure | 0.071 | 0.416 | 0.505 |
| data_coverage | 1.000 | 0.270 | 0.915 |
| intent_recall | 1.000 | 0.289 | 0.931 |

### Example 2: Text Embeddings

Next, the assessment of text embedding models on clustering performance was investigated using the re-parameterized iterative DBSCAN algorithm. The reparametrized iterative DBSCAN algorithm was compared across three text embedding configurations: MUSE (512 dimensions), ConveRT (512 dimensions), and the concatenation of MUSE and ConveRT (1024 dimensions). Each embedding configuration was evaluated by encoding natural language questions into fixed-dimensional vector representations, which were subsequently clustered using the iterative DBSCAN algorithm. Performance was measured using homogeneity, completeness, v-measure, data coverage, and intent recall metrics. The outcomes were analyzed to determine the influence of embedding selection on clustering quality.

As shown in Table 9, the experimental observations indicated that MUSE embeddings produced marginally superior results compared to ConveRT, as reflected by higher scores in homogeneity (0.356 versus 0.336), completeness (0.957 versus 0.939), and v-measure (0.505 versus 0.480). The concatenation of both models, despite resulting in a doubled embedding dimensionality (1024), did not yield significant improvement over MUSE alone and, in some cases, demonstrated diminished performance relative to the single-embedder approach. Data coverage and intent recall remained relatively consistent across all embedding variants, suggesting that the choice of embedding model primarily affected cluster purity and completeness rather than the overall breadth of clustered data.

TABLE 9

| | | | MUSE + |
|---|---|---|---|
| | MUSE | ConveRT | ConveRT |
| Metric | (512 dimension) | (512 dimension) | (1024 dimension) |
| homogeneity | 0.356 | 0.336 | 0.353 |
| completeness | 0.957 | 0.939 | 0.961 |
| v_measure | 0.505 | 0.480 | 0.500 |
| data_coverage | 0.915 | 0.914 | 0.920 |
| intent_recall | 0.931 | 0.931 | 0.934 |

### Example 3: Dimension Reduction

The impact of dimension reduction on clustering performance was investigated using the re-parameterized iterative DBSCAN algorithm with MUSE text embeddings. The UMAP algorithm for dimension reduction was used, wherein the embedding vectors were projected to lower-dimensional spaces of 128, 64, or 32 dimensions. Each configuration was assessed by clustering the reduced-dimension embeddings and evaluating the resultant clusters with respect to homogeneity, completeness, v-measure, data coverage, and intent recall. The analysis aimed to determine the effect of dimensionality on the quality of clusters produced in the Text-to-SQL question clustering task.

As highlighted in Table 10, the results demonstrated that moderate dimension reduction significantly improved clustering performance. When the embedding dimensionality was reduced from 512 to 128 using UMAP, the v-measure increased from 0.505 (without dimension reduction, i.e. 512) to 0.601 (with dimension reduction, i.e., 128). Further reduction to 64 dimensions maintained this improvement, while extreme dimension reduction to 32 dimensions resulted in a slight decline in v-measure from 0.601 (with dimension reduction of 128) to 0.589 (with dimension reduction of 32), suggesting diminished clustering quality at very low dimensionalities. Data coverage and intent recall remained robust across all tested dimensions, confirming that the principal gains were realized in homogeneity and completeness.

TABLE 10

| | Without | With | | |
|---|---|---|---|---|
| | Dimension Reduction | Dimension Reduction | | |
| Metric | 512 | 128 | 64 | 32 |
| homogeneity | 0.356 | 0.449 | 0.452 | 0.446 |
| completeness | 0.957 | 0.973 | 0.975 | 0.966 |
| v_measure | 0.505 | 0.601 | 0.601 | 0.589 |
| data_coverage | 0.915 | 0.941 | 0.939 | 0.936 |
| intent_recall | 0.931 | 0.957 | 0.954 | 0.951 |

### Example 4: Hyper-Tuning with Multiple Criteria

The effect of hyperparameter tuning on clustering performance was assessed using the re-parameterized iterative DBSCAN algorithm with MUSE or MUSE+ConveRT text embeddings. Each embedding model was hyper-tuned separately to increase the likelihood that the optimal parameters for each model would be found. Hyperparameter tuning was conducted on the Spider train set, and the resulting tuned parameters were evaluated on the Spider validation set. The experimental protocol involved two separate hyper-tuning criteria. The first criterion was based on an equally weighted combination of homogeneity and completeness. The second criterion was based on an equally weighted combination of homogeneity, completeness, data coverage, and intent recall. The search space for dimension reduction included the following options: choice of algorithm (UMAP or PCA) and choice of projecting dimensions (32, 64, 128, 256, or 384). The search space for re-parameterized iterative DBSCAN included the following potential values: minimum cluster sizes (3, 4, or 5), bottom distance quantiles (0.01, 0.50), and top distance quantiles (0.50, 0.99). Each configuration was systematically evaluated to identify parameter sets that generalized well across multiple database schemas, with clustering outcomes measured using the established metrics of homogeneity, completeness, v-measure, data coverage, and intent recall.

### Example 4A: Hyper-Tuning with Equally Weighted of Homogeneity and Completeness Criterion

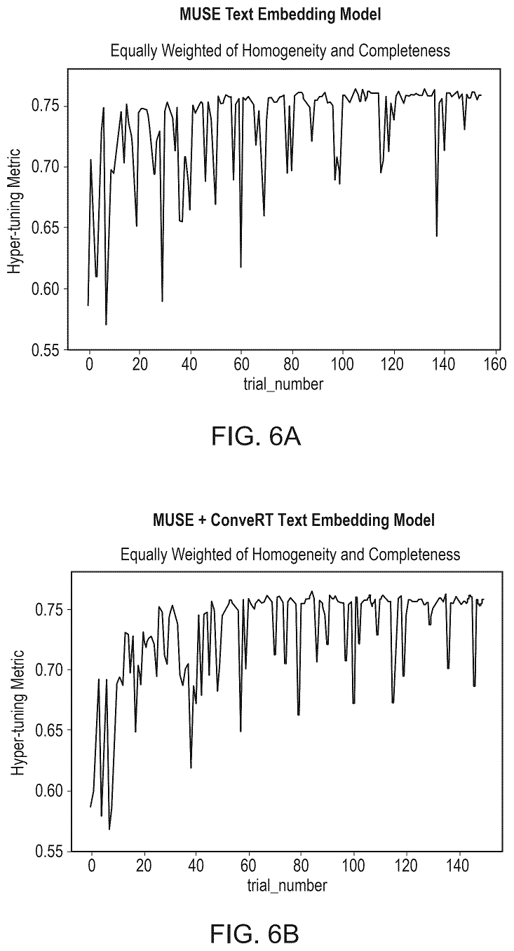

Under the first tuning criterion, which prioritized an equally weighted combination of homogeneity and completeness, both MUSE and MUSE+ConveRT embeddings demonstrated substantial gains in the target metric. Convergence of the tuning process typically occurred after approximately 100 iterations for both embedding models (see FIGS. 6A and 6B). On the Spider training set, hyper-tuned parameter settings for both embedding models achieved the same equally weighted homogeneity and completeness scores of 0.764 (see Table 11). On the Spider validation set, for both MUSE and MUSE+ConveRT, clustering performance on the hyper-tuned settings improved over baseline performance for homogeneity, completeness, and equally weighted homogeneity and completeness criterion (see Table 12). However, there was no significant difference in clustering performance between MUSE and MUSE+ConveRT hyper-tuned settings during validation (i.e., an EW value of 0.744 versus 0.742, respectively).

TABLE 11
Hyper-tuned Performance on the Spider Training Set

| | | EW of Homogeneity and |
|---|---|---|
| Model | Hyper-tuned | Completeness |
| MUSE | Yes | 0.764 |
| MUSE + ConveRT | Yes | 0.764 |

TABLE 12
Hyper-tuned Performance on the Spider Validation Set

| | | | | EW of |
|---|---|---|---|---|
| | Hyper- | | | Homogeneity and |
| Model | tuned | homogeneity | completeness | Completeness |
| MUSE | No | 0.310 | 0.938 | 0.624 |
| | Yes | 0.541 | 0.946 | 0.744 |
| MUSE + | No | 0.345 | 0.924 | 0.634 |
| ConveRT | Yes | 0.534 | 0.951 | 0.742 |

### Example 4B: Hyper-Tuning with Equally Weighted of Homogeneity and Completeness, Data Coverage, and Intent Recall Criterion

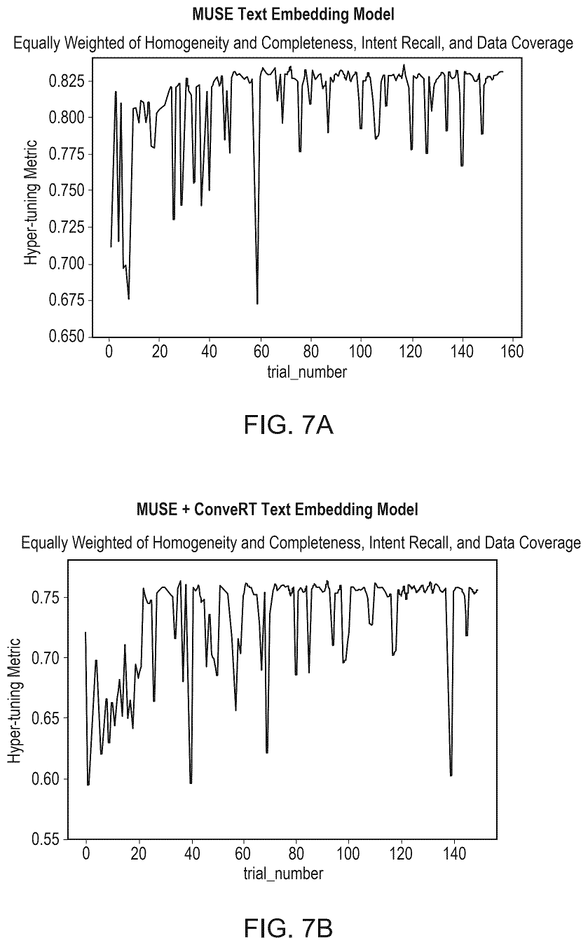

Under the second tuning criterion, which prioritized an equally weighted combination of homogeneity, completeness, data coverage, and intent recall, both MUSE and MUSE+ConveRT exhibited improvement in the target metric until hyper-tuning convergence at approximately 80 iterations (see FIGS. 7A and 7B). On the Spider training set, the EW of all four criteria was 0.835 for MUSE and 0.763 for MUSE+ConveRT (see Table 13). On the Spider validation set, for both MUSE and MUSE+ConveRT, clustering performance on the hyper-tuned settings were better than the baselines without hyper-tuning (see Table 14). When all four clustering criteria were considered, MUSE outperformed MUSE+ConveRT on both the Spider training set and validation set.

TABLE 13
Hyper-tuned Performance on the Spider Training Set

| Model | Hyper-tuned | EW of All Four Criteria |
|---|---|---|
| MUSE | Yes | 0.835 |
| MUSE + ConveRT | Yes | 0.763 |

TABLE 14
Hyper-tuned Performance on the Spider Validation Set

| | | | | | | EW of All |
|---|---|---|---|---|---|---|
| | Hyper- | homo- | complete- | Data | Intent | Four |
| Model | tuned | geneity | ness | coverage | recall | Criteria |
| MUSE | No | 0.310 | 0.938 | 0.941 | 0.955 | 0.786 |
| | Yes | 0.460 | 0.964 | 0.593 | 0.942 | 0.824 |
| MUSE + | No | 0.345 | 0.924 | 0.954 | 0.968 | 0.798 |
| ConveRT | Yes | 0.542 | 0.874 | 0.667 | 0.958 | 0.800 |

### Example 5: Seeding the Clustering Process with Existing In-Context Examples

The effect of seeding the clustering process with existing in-context examples was investigated using the re-parameterized iterative DBSCAN algorithm with the MUSE text embedding model. The same hyper-tuned settings used in Example 4 were also used in this experiment. The Spider validation set was extended by adding more examples from its synthetic and realistic variations. Then, all gold SQL groups with fewer than three variation questions were removed. The extended Spider validation set was split into two subsets: two-thirds of the examples were used for a seeding set (labeled data simulating available in-context examples) and one-third were used for a test set (unlabeled data simulating logged questions). It is noted that all data manipulations are handled at the database schema level and all final results were averaged across all database schemas. Clustering was performed on test sets, varying the proportions of labeled questions (i.e., seeds) from the corresponding training sets. The proportions of labeled questions ranged from 0% (unlabeled only) to 100% (equal numbers of labeled and unlabeled). At each proportion, ‘n’ labeled questions were added to the unlabeled data before clustering. For example, for a proportion of 20%, the value of ‘n’ is equal to 20%*the number of unlabeled questions. The evaluation metrics included homogeneity, completeness, v-measure, data coverage, and intent recall.

As shown in Tables 15 and 16, the experimental results demonstrated that increasing the proportion of labeled in-context examples mixed with unlabeled log questions prior to clustering led to substantial improvements in clustering performance across all metrics. At higher seeding levels, homogeneity, completeness, and v-measure exhibited significant gains, indicating tighter and purer clusters, while data coverage and intent recall remained relatively constant.

TABLE 15
MUSE Hyper-tuned with Equally Weighted of Homogeneity and Completeness

| | Only | | | | | | |
|---|---|---|---|---|---|---|---|
| | Logged | Proportion of labelled data over | | | | | Logged Questions + All |
| | Questions | unlabeled data | | | | | Available In-Context Examples |
| Metric | 0% | 20% | 40% | 60% | 80% | 100% | 200% |
| homogeneity | 0.494 | 0.484 | 0.610 | 0.656 | 0.687 | 0.722 | 0.857 |
| completeness | 0.917 | 0.905 | 0.918 | 0.923 | 0.898 | 0.924 | 0.962 |
| v_measure | 0.622 | 0.611 | 0.709 | 0.747 | 0.764 | 0.794 | 0.881 |
| data_coverage | 0.863 | 0.855 | 0.854 | 0.841 | 0.828 | 0.842 | 0.818 |
| intent_recall | 0.895 | 0.892 | 0.879 | 0.858 | 0.846 | 0.869 | 0.846 |
| 4_ew_criteria | 0.792 | 0.784 | 0.815 | 0.820 | 0.815 | 0.839 | 0.871 |

TABLE 16
MUSE Hyper-tuned with Equally Weighted of Homogeneity,
Completeness, Intent Recall, and Data Coverage

| | Only | | | | | | |
|---|---|---|---|---|---|---|---|
| | Logged | Proportion of labelled data over | | | | | Logged Questions + All |
| | Questions | unlabeled data | | | | | Available In-Context Examples |
| Metric | 0% | 20% | 40% | 60% | 80% | 100% | 200% |
| homogeneity | 0.414 | 0.399 | 0.526 | 0.544 | 0.587 | 0.599 | 0.741 |
| completeness | 0.904 | 0.907 | 0.915 | 0.904 | 0.897 | 0.891 | 0.973 |
| v_measure | 0.552 | 0.535 | 0.646 | 0.663 | 0.697 | 0.703 | 0.797 |
| data_coverage | 0.924 | 0.936 | 0.936 | 0.942 | 0.934 | 0.937 | 0.937 |
| intent_recall | 0.948 | 0.955 | 0.955 | 0.956 | 0.946 | 0.950 | 0.954 |
| 4_ew_criteria | 0.797 | 0.799 | 0.833 | 0.836 | 0.841 | 0.844 | 0.901 |

### Illustrative Method

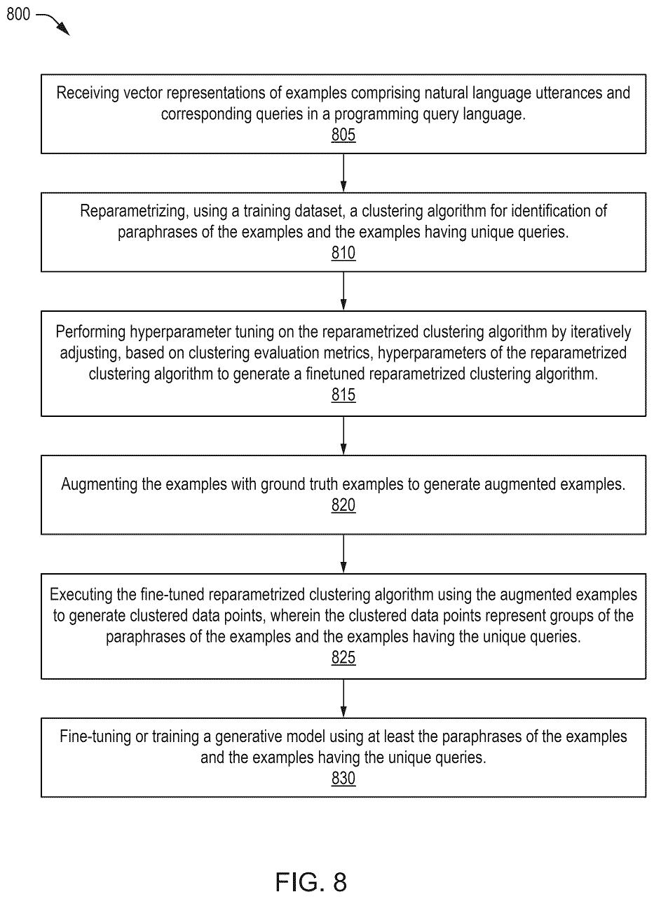

FIG. 8 is a flowchart illustrating a process 800 for leveraging a clustering algorithm for harvesting in-context examples from Text-to-SQL production logs, according to various embodiments. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1-4, the processing depicted in FIG. 8 may be performed by an agent system (e.g., SQL agent system 200 described with respect to FIG. 2).

At box 805, vector representations of examples comprising natural language utterances and corresponding queries in a programming query language are received. In various embodiments, the examples may be obtained from text-to-SQL logs generated during the operation of NL2SQL systems (e.g., SQL agent system 200 described with respect to FIG. 2). These logs reflect real-world user interactions with database query interfaces and may include both successful and unsuccessful attempts by users to retrieve information from underlying databases. Accordingly, the examples captured in the text-to-SQL logs constitute a valuable data source of candidate in-context examples, as they facilitate the identification of recurring or paraphrased questions as well as the emergence of new informational needs within the model. In this manner, these examples support the dynamic curation and continual refinement of in-context examples, thereby enhancing model performance and adaptability. In-context examples serve as reference demonstrations that guide the model in interpreting and generating appropriate responses to subsequent, previously unseen user queries.

In various embodiments, the vector representations are generated by first, embedding, by an embedding model, the natural language utterances and corresponding programming query language into vectors. The embedding model is a text embedding model, for example MUSE, ConveRT, or the concatenation of MUSE and ConveRT; however, other text embedding models may be considered, for example BERT, ROBERTa, CloVe, FastText, etc. Embedding model selection is based on clustering performance of the reparametrized clustering algorithm on the embedded natural language utterances and corresponding programming query language. Accordingly, hyperparameters of the embedding model are evaluated based on clustering evaluation metrics.

After embedding, the dimensions of the vectors are reduced using a dimension reduction algorithm to obtain the vector representations. The dimension reduction algorithm may be selected from a group comprising PCA, t-SNE, UMAP, LDA, Isomap, and the like. Selection of the dimension reduction algorithm is based on clustering performance of the reparametrized clustering algorithm on the reduced vectors. Accordingly, hyperparameters of the dimension reduction algorithm are evaluated based on the clustering evaluation metrics.

At box 810, a clustering algorithm is reparametrized, using the vector representations, for the identification of paraphrases of the examples and the examples having unique queries. Reparameterization is based on first sampling the vector representations to obtain a set of sampled vector representations. Then, parameter values for a local radius parameter are estimated from a distribution of pairwise distances determined between each of the sampled vector representation in the set of vector representations and each vector representation in the vector representations. Then, the clustering algorithm is iteratively executed on the set of sampled vector representations, based on incrementally relaxing density constraints from high-density to low-density clusters based on the estimated parameter values for the local radius parameter and parameter values for a minimum samples parameter, to generate a reparametrized clustering algorithm.

In various embodiments, estimating parameter values for the local radius parameter comprises, for each sampled vector representation in the set of vector representations: (i) computing distances between the sampled vector representation and each vector representation in the vector representations, (ii) identifying nearest neighbor distances and distant neighbor distances, and (iii) aggregating the nearest neighbor distances and the distant neighbor distances to generate a neighbor distance pairwise distribution corresponding to the vector representation.

From the list of neighbor distance pairwise distributions, an initial value, a final value, and an incremental value for the local radius parameter are determined. The initial value for the local radius parameter is a low percentile of the neighbor distance pairwise distributions for the subset of vector representations. In various instances, the low percentile corresponds to a value that is smaller than, for example, 95% of the other distances, to enable strict clustering at the outset. The final value for the local radius parameter is a high percentile of the neighbor distance pairwise distributions for the subset of vector representations. In various instances, the high percentile corresponds to a value that is greater than 95% of the other distances, to allow for more relaxed clustering in subsequent iterations. Accordingly, the low percentile value establishes the starting threshold for considering whether two examples are sufficiently similar to be considered neighbors, while the high percentile value defines the upper bound for similarity as the algorithm progresses. The incremental value for the local radius parameter is the difference between the final value and the initial value divided by a number of clustering iterations.

In various embodiments, the minimum samples parameter comprises a smallest minimum sample value, a largest minimum sample value, and an incremental value, wherein the incremental value is set so that cluster size progresses from tight/large clusters to looser/smaller clusters. In some instances, the smallest minimum sample value, a largest minimum sample value, and an incremental value are selected automatically by the system, are explicitly provided by the user, or are based on the hyper-tuning performance of the clustering algorithm.

In various embodiments, the reparametrizing further comprises, after each executed iteration of clustering, removing clustered data points from the vector representations such that subsequent iterations of the hyperparameter tuning are performed on un-clustered data points. Additionally, at the start of each new iteration, the local radius parameter is increased based on the incremental value, and the minimum cluster size parameter (min_samples) is decreased based on its corresponding incremental value. This iterative adjustment allows the clustering process to first capture the largest clusters with similar questions (e.g., large, tight clusters) and then include smaller clusters with less strictly related questions (e.g., small, loose clusters).

At box 815, hyperparameter tuning on the reparametrized clustering algorithm is performed by iteratively adjusting, based on clustering evaluation metrics, hyperparameters of the reparametrized clustering algorithm to generate a finetuned reparametrized clustering algorithm. In some instances, hyperparameter tuning initially involves using a labeled training dataset to tune the parameters of the reparametrized clustering algorithm. Then the tuned parameters are validated on a validation dataset to confirm the generalizability of the tuned parameters. In various instances, the validated parameters should perform robustly across a variety of domain spaces, thus the finetuned reparametrized clustering algorithm may be easily applied to new datasets with minimal additional tuning.

In various embodiments, the clustering evaluation metrics comprise a combination of at least two clustering evaluation metrics selected from a group consisting of homogeneity, completeness, v-measure, data coverage, and intent recall. In addition, the combination of the at least two clustering evaluation metrics is a weighted combination of the selected clustering evaluation metrics.

At box 820, the examples from box 805 are augmented with ground truth examples to generate augmented examples. In various embodiments, generating the augmented examples comprises adding a proportion of the ground truth examples to the examples, wherein the proportion is selected as a percentage of the number of examples.

At box 825, the fine-tuned reparametrized clustering algorithm is executed using the augmented examples to generate clustered data points, wherein the clustered data points represent groups of the paraphrases of the examples and the examples having the unique queries.

At box 830, a generative model is fine-tuned or trained using at least the paraphrases of the examples and the examples having the unique queries. In some instances, the generative model is an LLM configured for Text-to-SQL transformations. In some embodiments, to fine-tune or train the generative model, the paraphrases of the examples and the examples having the unique queries are integrated into a new training or fine-tuning dataset.

To integrate paraphrases of the examples, the system identifies clusters of natural language utterances that correspond to an existing labeled in-context example and associates each paraphrased utterance in the cluster with the same verified target query as the labeled in-context example. For example, if a cluster contains a labeled in-context example such as “Count the number of schools” mapped to the target SQL “SELECT count (*) FROM School,” and also includes paraphrased variants like “How many schools are there?”, the system adds each paraphrased utterance paired with the same target SQL query to the new training or fine-tuning dataset. This process increases the linguistic diversity of the training data and improves the model's robustness to varied user expressions.

To integrate examples having unique queries, the system identifies clusters that do not correspond to any existing labeled in-context example and obtains a verified ground-truth query for at least one representative utterance within the cluster. This may be accomplished through human annotation or by validating candidate queries via execution on the relevant database schema. The system then pairs one or more natural language utterances from the cluster with the verified ground-truth query and incorporates these pairs into the new training or fine-tuning dataset. For example, a cluster containing questions such as “Show the average, maximum, minimum enrollment of all schools” may be added with a verified target SQL query such as “SELECT avg (Enrollment), max (Enrollment), min (Enrollment) FROM School.”

Once the new training or fine-tuning dataset is assembled, the generative model is fine-tuned or trained by minimizing a token-level loss function (e.g., cross-entropy loss) between prompts containing schema/context information and the target SQL queries. Optionally, a held-out validation split may be employed to optimize training hyperparameters and to confirm that training on paraphrased items enhances robustness to linguistic variation, while training on unique-query items expands coverage to new informational intents. This approach ensures that the generative model remains adaptive and accurate as user needs and database schemas evolve, leveraging dynamically curated in-context examples harvested from production logs and clustering operations.

Once the generative model has been fine-tuned or trained, it may be deployed into a production environment to perform inference tasks on real-world input data. In various embodiments, the production environment may be part of an automated text-to-SQL agent system (e.g., SQL agent system 200 described with respect to FIG. 2) operating within a cloud-based infrastructure (e.g., IaaS cloud-based environment described and illustrated in FIGS. 9-13) or enterprise analytics platform. In various embodiments, the deployed model's inference accuracy, response times, and other operational metrics may be monitored to ensure the model continues to perform as expected over time. As the database is revised and/or as the needs of the user population evolve, the generative model may require retraining or updates to maintain optimal performance based on new data or changing conditions present in the production environment. In some embodiments, retraining may comprise re-executing the fine-tuned reparametrized clustering algorithm to harvest updated in-context examples from newly acquired production logs, so that these refreshed examples may be incorporated into the model's prompt or training corpus. This ongoing process supports the continued adaptability and accuracy of the generative model in response to dynamic operational requirements and evolving user queries.

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

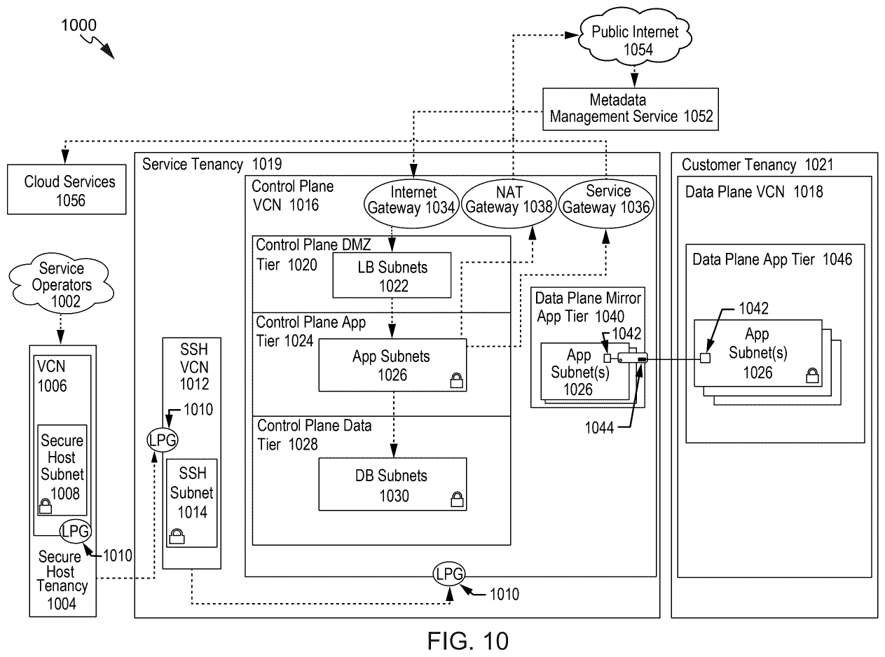

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

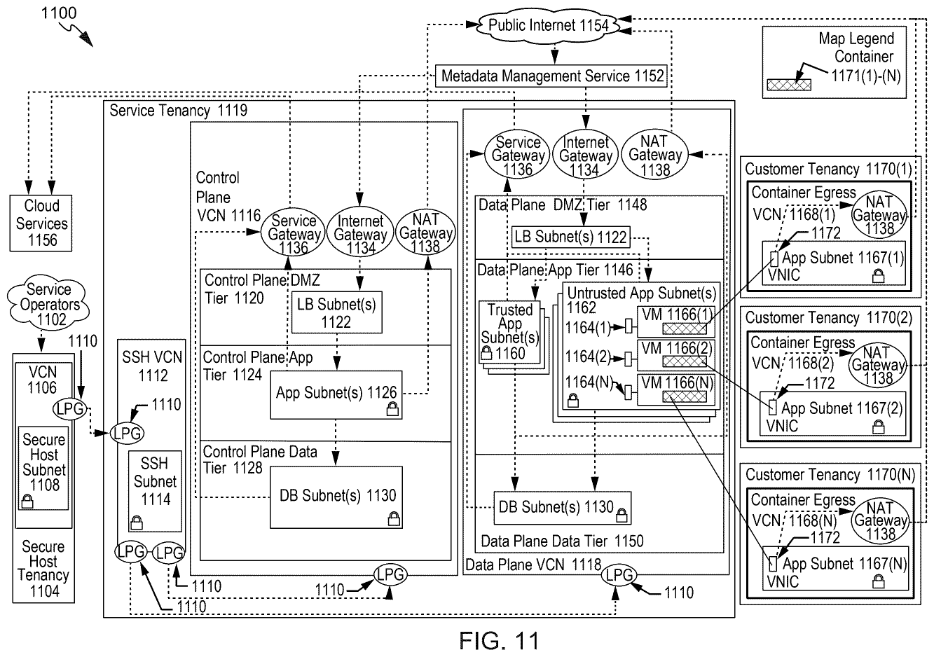

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

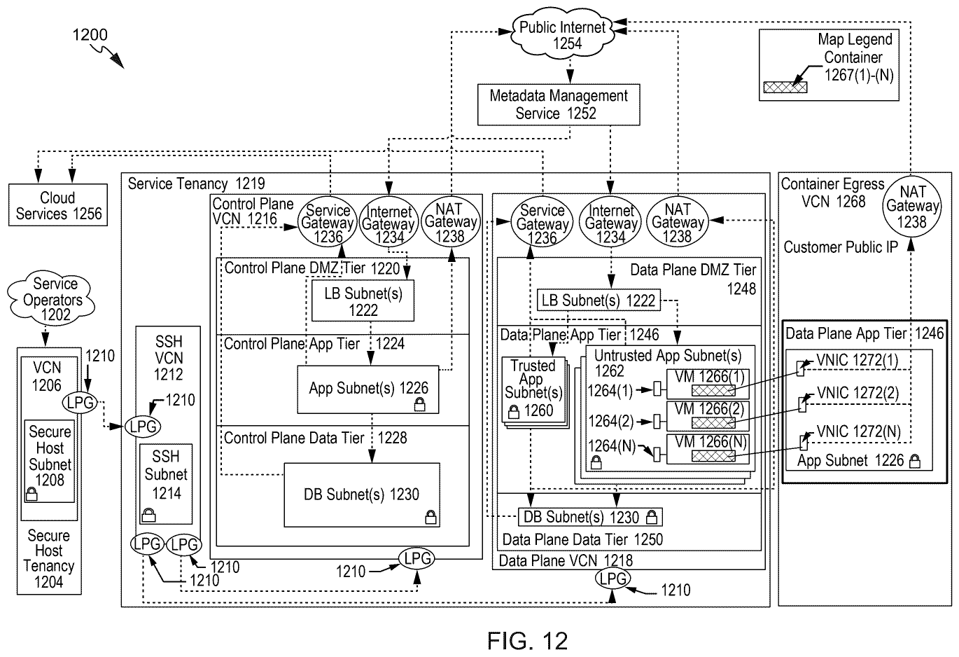

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

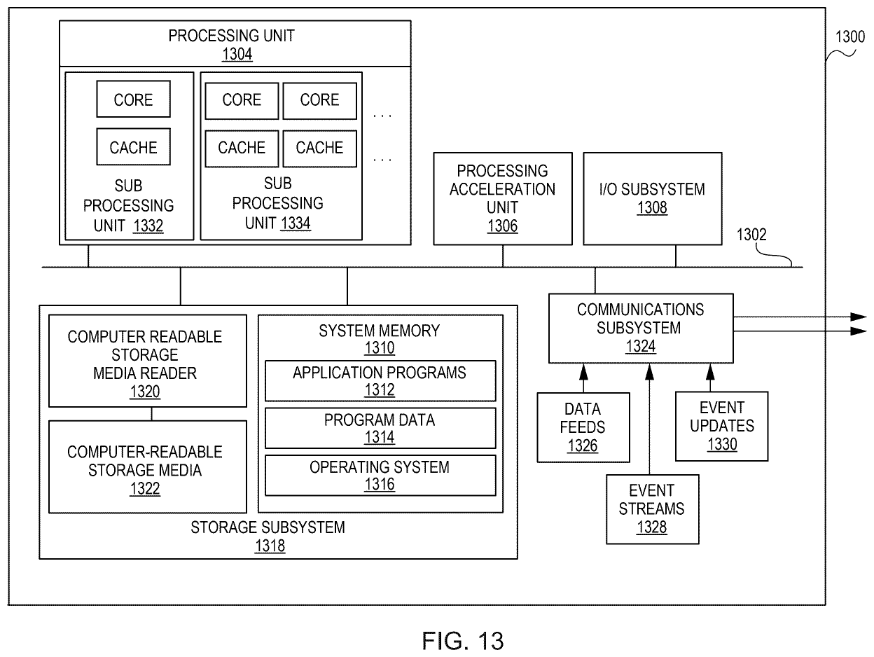

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving vector representations of examples comprising natural language utterances and corresponding queries in a programming query language;
reparametrizing, using the vector representations, a clustering algorithm for identification of paraphrases of the examples and the examples having unique queries, based on:
sampling the vector representations to obtain a set of sampled vector representations;
estimating parameter values for a local radius parameter from a distribution of pairwise distances determined between each of the sampled vector representation in the set of vector representations and each vector representation in the vector representations, and
iteratively executing the clustering algorithm on the set of sampled vector representations, based on incrementally relaxing density constraints from high-density to low-density clusters based on the estimated parameter values for the local radius parameter and parameter values for a minimum samples parameter, to generate a reparametrized clustering algorithm;
performing hyperparameter tuning on the reparametrized clustering algorithm by iteratively adjusting, based on clustering evaluation metrics, hyperparameters of the reparametrized clustering algorithm to generate a finetuned reparametrized clustering algorithm;
augmenting the examples with ground truth examples to generate augmented examples;
executing the fine-tuned reparametrized clustering algorithm using the augmented examples to generate clustered data points, wherein the clustered data points represent groups of the paraphrases of the examples and the examples having the unique queries; and
fine-tuning or training a generative model using at least the paraphrases of the examples and the examples having the unique queries.

2. The computer-implemented method of claim 1, wherein the vector representations are generated by:
embedding, by an embedding model, the natural language utterances and corresponding programming query language into vectors, wherein hyperparameters of the embedding model are evaluated based on clustering evaluation metrics; and
reducing, using a dimension reduction algorithm, dimensions of the vectors to obtain the vector representations, wherein hyperparameters of the dimension reduction algorithm are evaluated based on the clustering evaluation metrics.

3. The computer-implemented method of claim 1, wherein estimating parameter values for the local radius parameter comprises:
for each sampled vector representation in the set of vector representations:
(i) computing distances between the sampled vector representation and each vector representation in the vector representations,
(ii) identifying nearest neighbor distances and distant neighbor distances, and
(iii) aggregating the nearest neighbor distances and the distant neighbor distances to generate a neighbor distance pairwise distribution corresponding to the vector representation; and
determining an initial value for the local radius parameter as a low percentile of the neighbor distance pairwise distributions for the subset of vector representations, a final value for the local radius parameter as a high percentile of the neighbor distance pairwise distributions for the subset of vector representations, and an incremental value for the local radius parameter as the difference between the final value and the initial value divided by a number of clustering iterations.

4. The computer-implemented method of claim 1, wherein the minimum samples parameter comprises a smallest minimum sample value, a largest minimum sample value, and an incremental value, wherein the incremental value is set so that cluster size progresses from tight/large clusters to looser/smaller clusters.

5. The computer-implemented method of claim 1, wherein the reparametrizing further comprises, after each executed iteration of clustering, removing clustered data points from the vector representations such that subsequent iterations of the hyperparameter tuning are performed on un-clustered data points.

6. The computer-implemented method of claim 1, wherein:
the clustering evaluation metrics comprise a combination of at least two clustering evaluation metrics selected from a group consisting of homogeneity, completeness, v-measure, data coverage, and intent recall, and
the combination of the at least two clustering evaluation metrics is a weighted combination of the selected clustering evaluation metrics.

7. The computer-implemented method of claim 1, wherein generating the augmented examples comprises adding a proportion of the ground truth examples to the examples, wherein the proportion is selected as a percentage of the number of examples.

8. A system comprising:
one or more processors; and
one or more computer-readable media storing instructions which, when executed by the one or more processors, cause the system to perform operations comprising:
access production logs comprising natural language utterances and corresponding queries in a programming query language;
embedding, by an embedding model, the natural language utterances and corresponding queries in a programming query language into vectors;
reducing, using a dimension reduction algorithm, dimension of the vectors to obtain vector representations;
reparametrizing, using the vector representations, a clustering algorithm for identification of paraphrases of the examples and the examples having unique queries, based on:
sampling the vector representations to obtain a set of sampled vector representations;
estimating parameter values for a local radius parameter from a distribution of pairwise distances determined between each of the sampled vector representation in the set of vector representations and each vector representation in the vector representations, and
iteratively executing the clustering algorithm on the set of sampled vector representations, based on incrementally relaxing density constraints from high-density to low-density clusters based on the estimated parameter values for the local radius parameter and parameter values for a minimum samples parameter, to generate a reparametrized clustering algorithm;
performing hyperparameter tuning on the reparametrized clustering algorithm by iteratively adjusting, based on clustering evaluation metrics, hyperparameters of the reparametrized clustering algorithm to generate a finetuned reparametrized clustering algorithm;
augmenting the examples with ground truth examples to generate augmented examples;
executing the fine-tuned reparametrized clustering algorithm using the augmented examples to generate clustered data points, wherein the clustered data points represent groups of the paraphrases of the examples and the examples having the unique queries; and
fine-tuning or training a generative model using at least the paraphrases of the examples and the examples having the unique queries.

9. The system of claim 8, wherein estimating parameter values for the local radius parameter comprises:
for each vector representation in the subset of vector representations:
(i) computing distances between the vector representation and all other vector representations in the full set of vector representations, and
(ii) identifying nearest neighbor distances and distant neighbor distances, and
(iii) aggregating the nearest neighbor distances and the distant neighbor distances to generate a neighbor distance distribution corresponding to the vector representation; and
determining an initial value for epsilon as a low percentile of the neighbor-distance distributions for the subset of vector representations, a final value for epsilon as a high percentile of the neighbor-distance distributions for the subset of vector representations, and an incremental value for epsilon as the difference between the final value and the initial value divided by a number of clustering iterations.

10. The system of claim 8, wherein the minimum samples parameter comprises a smallest minimum sample value, a largest minimum sample value, and an incremental value, wherein the incremental value is set so that cluster size progresses from tight/large clusters to looser/smaller clusters.

11. The system of claim 8, wherein the reparametrizing further comprises, after each executed iteration of clustering, removing clustered data points from the vector representations such that subsequent iterations of the hyperparameter tuning are performed on un-clustered data points.

12. The system of claim 8, wherein
the clustering evaluation metrics comprise a combination of at least two clustering evaluation metrics selected from a group consisting of homogeneity, completeness, v-measure, data coverage, and intent recall, and
the combination of the at least two clustering evaluation metrics is a weighted combination of the selected clustering evaluation metrics.

13. The system of claim 8, wherein generating the augmented examples comprises adding a proportion of the ground truth examples to the examples, wherein the proportion is selected as a percentage of the number of examples.

14. One or more non-transitory computer-readable media storing instructions which, when executed by one or more processors, cause the one or more processors to perform operations comprising:
reparametrizing, using vector representations of examples, a clustering algorithm for identification of paraphrases of the examples and the examples having unique queries, based on:
sampling the vector representations to obtain a set of sampled vector representations;
estimating parameter values for an initial value, a final value, and an incremental value of a local radius parameter from a distribution of pairwise distances determined between each of the sampled vector representation in the set of vector representations and each vector representation in the vector representations,
determining parameter values for a smallest minimum sample value, a largest minimum sample value, and an incremental value of a minimum samples parameter, and
iteratively executing the clustering algorithm on the set of sampled vector representations, based on incrementally relaxing density constraints from high-density to low-density clusters based on the estimated parameter values for the local radius parameter and the determined parameter values for the minimum samples parameter, to generate a reparametrized clustering algorithm;
performing hyperparameter tuning on the reparametrized clustering algorithm by iteratively adjusting, based on clustering evaluation metrics, hyperparameters of the reparametrized clustering algorithm to generate a finetuned reparametrized clustering algorithm;
augmenting the examples with ground truth examples to generate augmented examples;
executing the fine-tuned reparametrized clustering algorithm using the augmented examples to generate clustered data points, wherein the clustered data points represent groups of the paraphrases of the examples and the examples having the unique queries; and
fine-tuning or training a generative model using at least the paraphrases of the examples and the examples having the unique queries.

15. The one or more non-transitory computer-readable media of claim 14, wherein the examples comprise natural language utterances and corresponding queries in a programming query language obtained from production logs.

16. The one or more non-transitory computer-readable media of claim 14, wherein the vector representations are generated by:
embedding, by an embedding model, the examples, wherein hyperparameters of the embedding model are evaluated based on clustering evaluation metrics; and
reducing, using a dimension reduction algorithm, dimensions of the vectors to obtain the vector representations, wherein hyperparameters of the dimension reduction algorithm are evaluated based on the clustering evaluation metrics.

17. The one or more non-transitory computer-readable media of claim 14, wherein estimating parameter values for the initial value, the final value, and the incremental value of a local radius parameter comprises:
for each sampled vector representation in the set of vector representations:
(i) computing distances between the sampled vector representation and each vector representation in the vector representations,
(ii) identifying nearest neighbor distances and distant neighbor distances, and
(iii) aggregating the nearest neighbor distances and the distant neighbor distances to generate a neighbor distance pairwise distribution corresponding to the vector representation; and
determining the initial value for the local radius parameter as a low percentile of the neighbor distance pairwise distributions for the subset of vector representations, the final value for the local radius parameter as a high percentile of the neighbor distance pairwise distributions for the subset of vector representations, and the incremental value for the local radius parameter as the difference between the final value and the initial value divided by a number of clustering iterations.

18. The one or more non-transitory computer-readable media of claim 14, wherein the smallest minimum sample value, the largest minimum sample value, and the incremental value, are set so that cluster size progresses from tight/large clusters to looser/smaller clusters.

19. The one or more non-transitory computer-readable media of claim 14, wherein the reparametrizing further comprises, after each executed iteration of clustering, removing clustered data points from the vector representations such that subsequent iterations of the hyperparameter tuning are performed on un-clustered data points.

20. The one or more non-transitory computer-readable media of claim 14, wherein:
the clustering evaluation metrics comprise a combination of at least two clustering evaluation metrics selected from a group consisting of homogeneity, completeness, v-measure, data coverage, and intent recall, and
the combination of the at least two clustering evaluation metrics is a weighted combination of the selected clustering evaluation metrics.
